(19) United States
(12) Patent Application Publication
(10) Pub. No.: US 2025/0260695 A1
(43) Pub. Date: Aug. 14, 2025

(54) METHODS, APPARATUS, AND ARTICLES OF MANUFACTURE TO SECURELY SHARE DATA

(71) Applicant: Openchip & Software Technologies S.L., Barcelona (ES)

(72) Inventors: Francesc Guim Bernat, Barcelona (ES); Gaspar Mora Porta, Castellon de la Plana (ES); Violante Moschiano, Avezzano (IT); Edgar Gonzalez Pellicer, Girona (ES); Tommaso Vali, Sezze (IT); Ignacio Astilleros Diez, Madrid (ES)

(21) Appl. No.: 19/195,235

(22) Filed: Apr. 30, 2025

Related U.S. Application Data
(63) Continuation of application No. PCT/IB2025/000066, filed on Jan. 31, 2025.

(30) Foreign Application Priority Data
Jan. 31, 2025 (WO) PCT/IB2025/000066

(51) Int. Cl. H04L 9/40

(52) U.S. Cl. CPC H04L 63/101; H04L 63/0435; H04L 63/0823

(57) ABSTRACT

Systems, apparatus, articles of manufacture, and methods are disclosed to securely share data. An example apparatus includes at least one first programmable circuit to obtain an access control list for an encrypted data object via a first communication channel with a data provider, the encrypted data object to be provided by the data provider via a second communication channel. Additionally, the example apparatus includes memory controller circuitry to permit or deny a request from at least one second programmable circuit to access the encrypted data object based on the access control list for the encrypted data object.

### RELATED APPLICATION(S)

This patent arises from a continuation of International Patent Application No. PCT/IB2025/000066, which was filed on Jan. 31, 2025. Priority to International Patent Application No. PCT/IB2025/000066 is hereby claimed. International Patent Application No. PCT/IB2025/000066 is incorporated herein by reference in its entirety.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### FIELD OF THE DISCLOSURE

This disclosure relates generally to data privacy and, more particularly, to methods, apparatus, and articles of manufacture to securely share data.

### BACKGROUND

Data privacy is a critical aspect of edge and data center deployments. Efforts to protect data include hardware assisted compute and memory security frameworks. Such hardware assisted compute and memory security frameworks include network cryptography, secure enclaves, and total memory encryption.

### BRIEF DESCRIPTION OF THE DRAWINGS

FIG. 1 is a block diagram of an example processing flow to analyze example X-ray images.

FIG. 2 is a block diagram of an example system including an example compute device that communicates with an example data provider to securely store an example data object in example memory.

FIG. 3 is a block diagram illustrating a first example communication path for the data provider of FIG. 2 to configure and check access properties of the data object of FIG. 2 and a second example communication path for storage of and access to the data object.

FIG. 4A is a block diagram of an example operation sequence to configure access properties of the data object of FIG. 2, store the data object, and control access to the data object.

FIG. 4B is a block diagram of an example operation sequence to configure access properties of the data object of FIG. 2 and control access to the data object based on communication with an example access control system.

FIG. 5 is a flowchart representative of example machine-readable instructions and/or example operations that may be executed, instantiated, and/or performed by example programmable circuitry to implement the data provider of FIGS. 2-4B.

FIG. 6 is a flowchart representative of example machine-readable instructions and/or example operations that may be executed, instantiated, and/or performed by example programmable circuitry to implement the vendor exclusive programmable circuit of FIGS. 2-4B.

FIG. 7 is a flowchart representative of example machine-readable instructions and/or example operations that may be executed, instantiated, and/or performed by example programmable circuitry to implement the memory controller circuitry of FIGS. 2-4B.

FIG. 8 is a flowchart representative of example machine-readable instructions and/or example operations that may be executed, instantiated, and/or performed by example programmable circuitry to implement the user software stack of FIGS. 2-4B.

FIG. 9 illustrates an example hardware arrangement of an example data center.

FIG. 10A illustrates an example arrangement of an example chip assembly of FIG. 9

FIG. 10B illustrates an example arrangement of an example chip assembly of FIG. 9, adapted for high-performance computing applications.

FIG. 11 is a block diagram of an example processing platform including programmable circuitry structured to execute, instantiate, and/or perform the example machine-readable instructions and/or perform the example operations of FIGS. 5-8 to implement the example compute device and/or the example data provider of FIGS. 2-4B.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine-readable instructions of FIGS. 5-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Data privacy is an aspect of edge and data center deployments. Example hardware assisted compute and memory security frameworks include network cryptography to protect communication channels between two points (e.g., secure sockets layer (SSL) encryption, transport layer security (TLS) encryption, etc.). Additionally, example hardware assisted compute and memory security frameworks include secure enclaves to protect execution of particular processes.

As used herein, a secure enclave is a secure execution environment that is isolated from other executable code (e.g., code executing on a main processor). A secure enclave may be implemented by software (e.g., one or more trusted execution environments (TEEs) such as container(s) and/or virtual machine(s) (VM(s))) executed from a private region of memory and/or as a physically separate hardware processor that executes code separate from the main processor. The terms secure enclave and TEE are used interchangeably. Secure enclaves allow applications to safely process data and/or perform operations within the secure enclave.

Example hardware assisted compute and memory security frameworks also include total memory encryption (TME). For example, TME encrypts all data passing to and from a central processor unit (CPU) including data on external memory busses of the CPU. An example of TME is multi-key TME (MKTME) which allows for multiple encryption keys to be used to encrypt different portions of memory with different encryption keys. As such, data encrypted with one encryption key can be securely stored in the same memory as data encrypted with another encryption key. TME protects data that is stored in non-volatile (e.g., persistent) memory and/or data that is stored in volatile memory. As such, example hardware assisted compute and memory security frameworks allow end-users to protect data from disclosure to other entities (e.g., nefarious entities), one or more applications executed by a compute device, and even from a vendor of a compute device.

There are some situations where an end-user may want to share some data with one entity but not another. For example, an end-user (e.g., owner of a compute device, owner of a deployment including multiple compute devices, etc.) may desire to share certain types of data with a hardware vendor to improve performance of a device purchased from the hardware vendor. For such a scenario it may be assumed that the hardware vendor is trusted. In some examples, an end-user may want to share an ambient condition (e.g., temperature, brightness, etc.) monitored by an external sensor with a vendor of a compute device to allow the vendor to better manage an operational characteristic of the compute device (e.g., fan speed, screen brightness, etc.). Additionally or alternatively, an end-user may want to share data generated by a camera with a vendor of a compute device to allow the vendor to improve at least one model that is accessible by the compute device (e.g., a model for sleep and wake states of the compute device).

In some examples, an end-user (e.g., owner of a compute device, owner of a deployment including multiple compute devices, etc.) may want to control which consumers can access data generated by a sensor. For example, an end-user may want to control which consumers can access data to comply with a regulation or law such as the General Data Protection Regulation (GDPR) in the European Union. Additionally or alternatively, an end-user may want to control which data consumer can access data to comply with a regulation or law such as the Health Insurance Portability and Accountability Act (HIPAA) in the United States, the Biometric Information Privacy Act (BIPA) in Illinois, and/or the California Consumer Privacy Act (CCPA) in California.

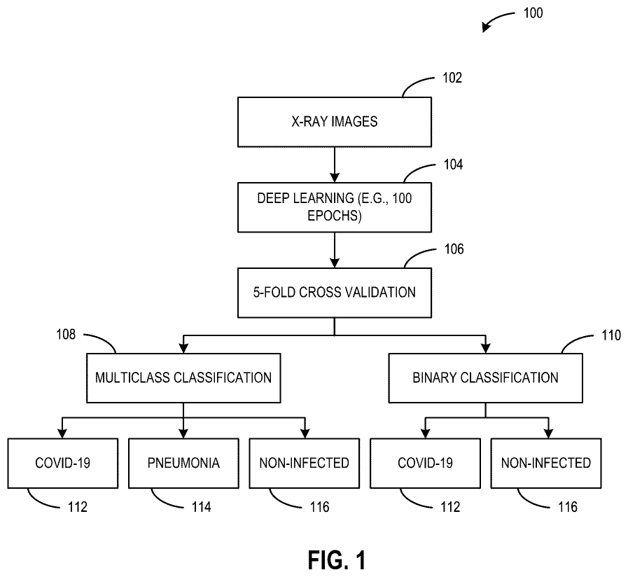

FIG. 1 is a block diagram of an example processing flow 100 to analyze example X-ray images 102. In the example of FIG. 1, the processing flow 100 includes an example deep learning stage 104 in which a machine learning (ML)/artificial intelligence (AI) model processes a training subset of the X-ray images 102. For example, the deep learning stage 104 includes processing the training subset of the X-ray images 102 with the ML/AI model over 100 epochs to train the ML/AI model. Example ML/AI models may include, for example, at least one of a convolutional neural networks (CNNs), recurrent neural networks (RNNs), long short-term memory (LSTM) networks, deep belief networks (DBNs), autoencoder networks, encoder-decoder networks, generative adversarial networks (GANs), radial basis function networks (RBFNs), and multilayer perceptron (MLP) networks, among others.

In the illustrated example of FIG. 1, the processing flow 100 includes an example validation stage 106 during which the ML/AI model is validated on a validation subset of the X-ray images 102. For example, the validation stage 106 includes a five-fold cross validation of the ML/AI model in which the ML/AI model processes five subgroupings of the validation subset of the X-ray images 102 to evaluate performance of the ML/AI model (e.g., accuracy, loss, etc.). Depending on the architecture of the ML/AI model, the processing flow 100 includes an example multiclass classification stage 108 or an example binary classification stage 110. In the classification stages 108 and 110, an ML/AI model processes X-ray images (e.g., the X-ray images 102, additional X-ray images, etc.) to determine if the X-ray images depict symptoms of an illness. For example, in the multiclass classification stage 108, an ML/AI model categorizes an X-ray image as falling into an example COVID-19 class 112, an example pneumonia class 114, or an example non-infected class 116. In the binary classification stage 110, an ML/AI model categorizes an X-ray image as falling into the COVID-19 class 112 or the non-infected class 116.

To perform the processing flow 100 of FIG. 1, an end-user of one or more compute devices (e.g., owner of the compute device, owner of a deployment including multiple compute devices, etc.), may need to limit which consumers in an organization can access X-ray images and/or associated metadata produced by an X-ray machine to comply with a regulation (e.g., the GDPR, the HIPAA, the BIPA, the CCPA, etc.).

For example, an end-user may want to split access to a data object into three groups, group A, group B, and group C. In such an example, the end-user may want to ensure that data consumers belonging to group A are permitted to access all of the raw data generated by the X-ray machine. Data consumers in group A may be doctors in a certain group in a hospital (e.g., doctors belonging to the radiology department). In such an example, the end-user may want to ensure that data consumers belonging to group B are only permitted to access some or all of the metadata associated with X-ray images produced by the X-ray machine. Example metadata includes age or sex of a patient captured in an X-ray image. Data consumers in group B may be researchers within the hospital. Additionally, in such an example, the end-user may want to ensure that data consumers in group C have reduced access compared to those in group B. For example, the end-user may want to ensure that data consumers in group C are only permitted access metadata indicating when an X-ray image was captured.

While hardware assisted compute and memory security frameworks allow an end-user to secure data generated by an entity associated with (e.g., external to, resident on, etc.) a compute device (e.g., an external sensor, an X-ray machine, a camera, an application, etc.), hardware assisted compute and memory security frameworks do not provide an end-user with more granular control over how data is shared. That is, there is no hardware-based technique to allow an end-user to have more granular control over access to data. For example, end-users cannot tag data objects with multiple security policies that permit different data consumers to access a data object differently.

Instead, some approaches rely on the end-user software stack or the system software stack executed by a programmable circuit of a compute device to analyze secured data that is intended for specific use. As such, control of access privileges to secured data is managed by the end-user software stack or the system software stack and not the data provider. Furthermore, because the data is accessed by the system software stack, the data is at risk of exposure to other entities (e.g., nefarious entities, applications executed by a compute device, etc.) not intended to have access to the data. As such, data intended for exclusive use by certain data consumers (e.g., the hardware of the compute device to train an ML/AI model run by the compute device) is not secured from access by other data consumers (e.g., the end-user and/or system software stacks) either during transmission or when stored.

Examples disclosed herein include computer hardware for data privacy operations, applicable in processor architectures such as chiplet-based processors, System-on-chip (SoC) circuitry, System-in-Package (SiP) or System-on-Package (SoP) circuitry, and/or any other modular packaging implementations of programmable circuitry. The following hardware examples specifically provide example methods, apparatus, and articles of manufacture to securely share data. For example, disclosed methods, apparatus, and articles of manufacture include a hardware system computer resident on a compute device that is an exclusive and separate compute domain from one or more main programmable circuits of the compute device. For example, the hardware system computer is a computer resident on the compute device that is reserved for exclusive access by a vendor of the compute device. In examples disclosed herein, the hardware system computer provides an in-band interface and/or an out-of-band interface to allow entities (e.g., software executed by the one or more main programmable circuits, external entities such as cameras or sensors, etc.) to register with and create a secure channel with the hardware system computer.

As such, examples disclosed herein allow for entities to provide a compute device with encrypted data that is controlled by the hardware system computer. For example, the hardware system computer controls access to encrypted data provided by an entity such that only the hardware system computer, software executed by the hardware system computer (e.g., for a specific purpose), and/or one or more data consumers permitted by the entity can access the encrypted data and/or associated metadata. Thus, the example hardware system computer disclosed herein controls access to data to permit secure and exclusive access to the data to perform specific processing. For example, the hardware system computer can permit a limited subset of data consumers to use the data to train one or more models.

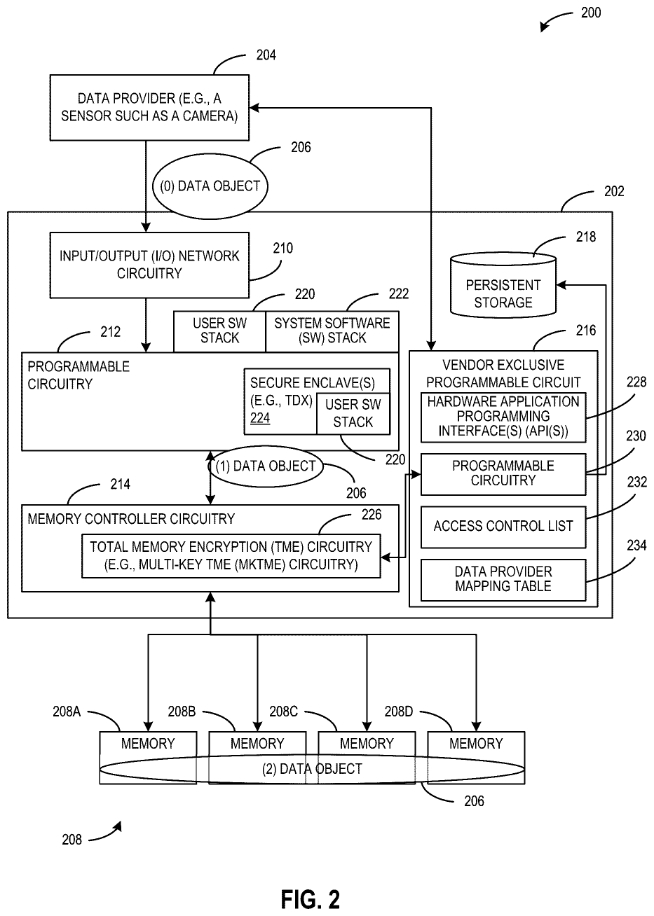

FIG. 2 is a block diagram of an example system 200 including an example compute device 202 that communicates with an example data provider 204 to securely store an example data object 206 in example memory 208. For example, the system 200 allows the data provider 204 (e.g., an external device or sensors such as an X-ray machine) to configure a secure communication path to provide a secure stream of data to particular storage media (e.g., the memory 208 or other storage device). Once the communication path (e.g., channel) is created, the data provider 204 can determine how particular data can be accessed and by which entities (e.g., data consumers).

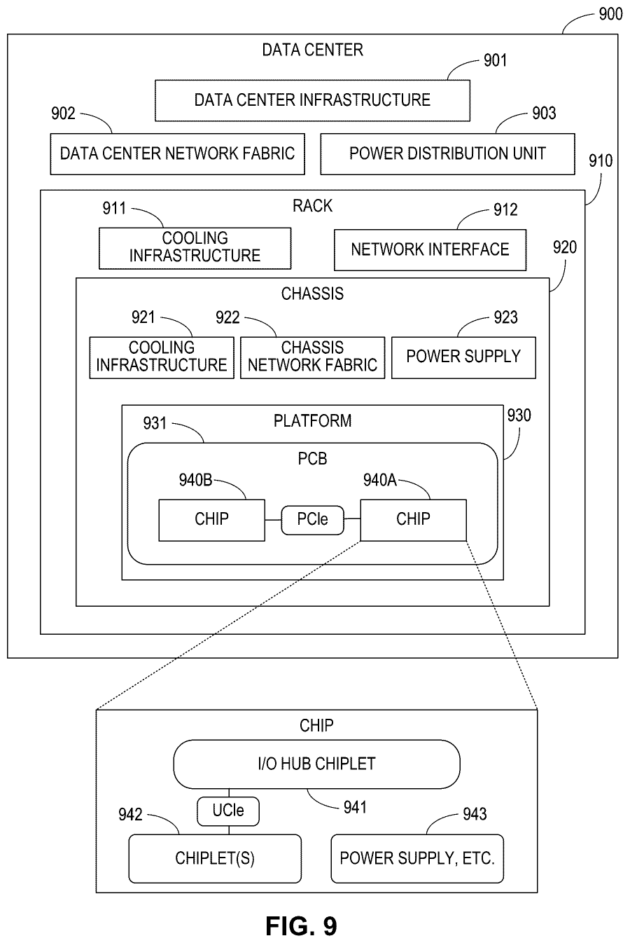

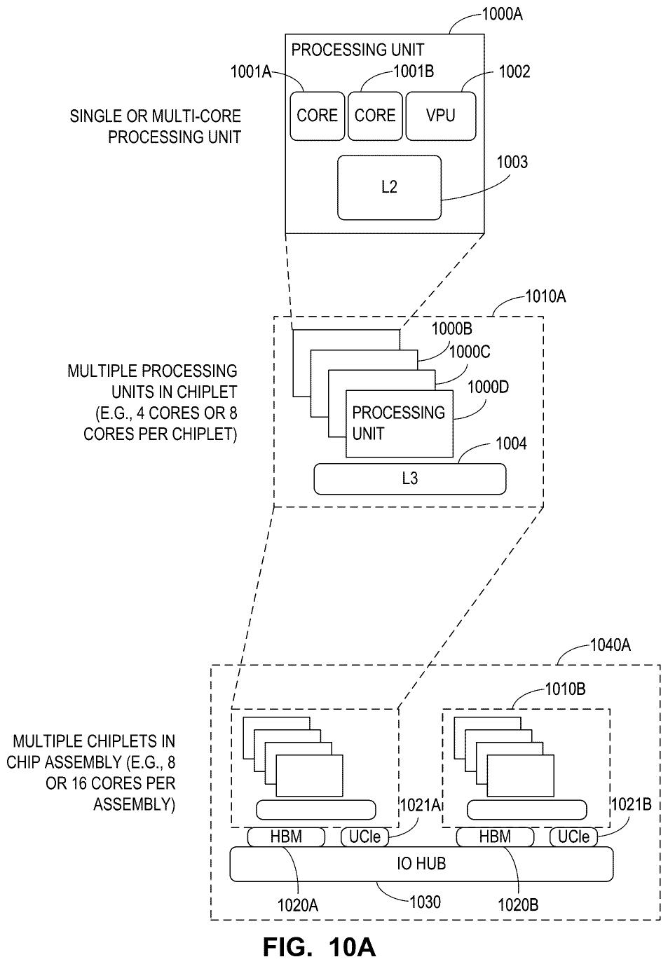

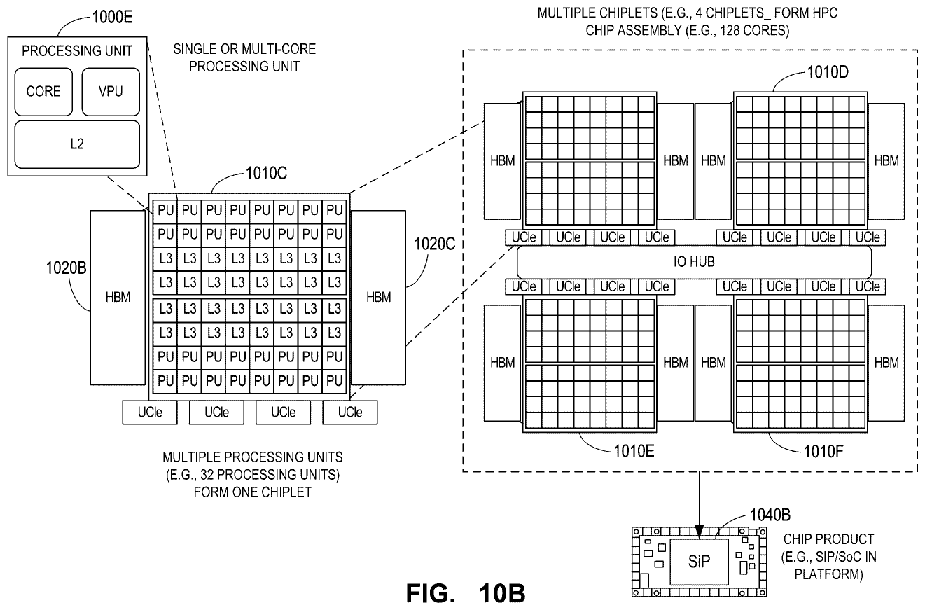

In the illustrated example of FIG. 2, the compute device 202 is implemented by a processor architecture such as chiplet-based programmable circuitry, SoC circuitry, SiP or SoP circuitry, and/or any other modular packaging implementation of programmable circuitry. As used herein, a chiplet refers to any integrated circuit (IC) that has a modular structure designed to have one or more specified functionalities and to be combinable with other chiplets on an interposer or other substrate in a package. Examples of chiplets are compute chiplets that include programmable circuitry (e.g., one or more logic and/or arithmetic circuits, such as one or more cores, etc.) and supporting circuitry (e.g., local memory, etc.) to provide processor functionality (e.g., to execute a host operating system (OS), applications, etc.), memory chiplets that include memory accessible to one or more other chiplets, communication chiplets that include communication interfaces (e.g., input/output hubs, networks, etc.) to enable other chiplets to communicate with each other and/or to other devices external to the package, etc. Example multi-tier management architectures provide a flexible management architecture that is multi-tiered to enable management of chiplet-based compute devices that include various combinations of chiplets from various manufacturers. Example chiplets are further described below in conjunction with FIGS. 9, 10A, and 10B.

As used herein, a tile refers to any IC that has a modular structure designed to have one or more specified functionalities and to be combinable with other tiles in a chiplet. For example, tiles can group one or more functional circuits into a single tile to implement a specified feature and/or group of features. Furthermore, tiles from different manufacturers can be combined into a given chiplet, and/or tiles can be replicated for inclusion in a given chiplet. Examples of tiles are compute tiles that include one or more programmable circuits (e.g., cores) and supporting circuitry (e.g., local memory) to provide processor functionality (e.g., to execute a host OS, applications, etc.) in a chiplet, memory tiles that include memory accessible to one or more other tiles in the chiplet, memory controller tiles to control access to the memory tiles in the chiplets, etc. In some examples, individual tiles and/or individual chiplets are implemented on separate dies (e.g., semiconductor dies) from other tiles and/or chiplets. Additionally or alternatively, two or more tiles and/or two or more chiplets are implemented on a common die.

In the illustrated example of FIG. 2, the compute device 202 includes example input/output (I/O) network circuitry 210, example programmable circuitry 212, example memory controller circuitry 214, an example vendor exclusive (VE) programmable circuit 216, and example persistent storage 218. In the example of FIG. 2, the I/O network circuitry 210 is in communication with the data provider 204 and the programmable circuitry 212. The example I/O network circuitry 210 is implemented by hardware (e.g., a chiplet, one or more tiles, etc.) in accordance with any type of interface standard, such as a Peripheral Component Interconnect (PCI) interface, a Peripheral Component Interconnect Express (PCIe) interface, and/or a Compute Express Link (CXL) interface such as the CXL interface for cache-coherent accesses to system memory (CXL.cache or CXL.$), the CXL interface for device memory (CXL.Mem), or the CXL interface for PCIe-based I/O devices (CXL.IO/PCIe). Additionally or alternatively, the I/O network circuitry 210 is implemented by hardware in accordance with an Ethernet interface, a universal serial bus (USB) interface, a Bluetooth® interface, and/or a near field communication (NFC) interface. In some examples, the I/O network circuitry 210 is implemented by hardware in accordance with a die-to-die interconnect such as an embedded multi-die interconnect bridge (EMIB), a co-EMIB, a high bandwidth memory (HBM) interconnect, a chip-on-wafer-on-substrate (CoWoS) interconnect, an integrated fan-out (InFO) interconnect, and/or an organic substrate-based interconnect.

In the illustrated example of FIG. 2, the programmable circuitry 212 is in communication with the I/O network circuitry 210 and the memory controller circuitry 214. In some examples, the programmable circuitry 212 is in communication with the VE programmable circuit 216. In the example of FIG. 2, the programmable circuitry 212 is implemented by one or more processor cores of a compute device. For example, in a 68-core processor, the programmable circuitry 212 is implemented by 64 cores of the processor. In some examples, the programmable circuitry 212 is implemented by one or more chiplets and/or one or more tiles. In the example of FIG. 2, the programmable circuitry 212 executes an example user software stack 220 and an example system software stack 222. The example user software stack 220 corresponds to an application run by an end-user. For example, the user software stack 220 may correspond to an ML/AI model and/or processing flow to operate an ML/AI model such as the processing flow 100 of FIG. 1. In some examples, the user software stack 220 is developed by the end-user. Additionally or alternatively, the user software stack 220 may be developed by a third party and executed by the end-user.

In the illustrated example of FIG. 2, the system software stack 222 corresponds to an operating system (OS) of the compute device 202. For example, the system software stack 222 corresponds to a bare metal OS. As used herein, a bare metal OS refers to an OS that has access to the physical resources (e.g., hardware and/or firmware) of a compute device (e.g., the compute device 202). In some examples, the bare metal OS corresponds to a host OS that executes on the compute device 202 to provide applications with access to the physical resources of the compute device 202. In some examples, the bare metal OS is a physical OS that executes below a virtual OS on the compute device 202 and that provides the virtual OS with access to the physical resources of the compute device 202.

In some examples, the programmable circuitry 212 includes an example secure enclave 224 from which the user software stack 220 is executed. In some examples, the secure enclave 224 is implemented by a Software Guard Extensions (SGX) enclave provided by Intel Corporation® or a Trust Domain Extensions (TDX) enclave provided by Intel Corporation®. Additionally or alternatively, the secure enclave 224 may be implemented by a MultiZone™ Security provided by Hex Five Security, a Keystone Customizable TEE, or a scalable TEE for a reduced instruction set computer (RISC)-V architecture compute device such as a scalable TEE developed by Penglai. In some examples, the secure enclave 224 is implemented by a Platform Security Processor (PSP) provided by Advanced Micro Devices (AMD), Inc. or a Secure Encrypted Virtualization (SEV) enclave provided by AMD, Inc. In some examples, the secure enclave 224 is implemented by a TrustZone® provided by Advanced RISC Machine (ARM) Holdings public limited company (PLC).

In the illustrated example of FIG. 2, the memory controller circuitry 214 is in communication with the programmable circuitry 212, the VE programmable circuit 216, and the memory 208. The memory 208 of this example is a bank of memory which includes multiple instances of memory to support a multi-channel interface between the memory bank 208 and the compute device 202. In the example of FIG. 2, the memory bank 208 includes a first example memory 208A, a second example memory 208B, a third example memory 208C, and a fourth example memory 208D. In the example of FIG. 2, the memory controller circuitry 214 is in communication with the first memory 208A, the second memory 208B, the third memory 208C, and the fourth memory 208D.

In the illustrated example of FIG. 2, the memory controller circuitry 214 is implemented by hardware (e.g., a chiplet, one or more tiles, etc.) in accordance with any type of memory interface standard, such as a Joint Electron Device Engineering Council (JEDEC) standard. Example JEDEC standards include double data rate (DDR) standards such as DDR, DDR2, DDR3, DDR4, DDR5, and DDR6. Additional or alternative DDR standards include mobile DDR (MDDR) standards such as low power DDR (LPDDR), LPDDR2, LPDDR3, LPDDR4, LPDDR5, LPDDR6, etc. DDR standards also include graphics DDR (GDDR) standards such as GDDR, GDDR2, GDDR3, GDDR4, GDDR5, and GDDR6. In some examples, the memory interface standard is a RAMBUS® standard such as extreme data rate (XDR) or XDR2.

In the illustrated example of FIG. 2, the memory controller circuitry 214 includes example total memory encryption (TME) circuitry 226. For example, the TME circuitry 226 of this example is implemented by one or more chiplets and/or one or more tiles. In some examples, the TME circuitry 226 is implemented to support MKTME. Additionally or alternatively, the TME circuitry 226 and/or any circuitry implemented by the TME circuitry 226 is implemented by internal and/or external to the compute device 202 (e.g., the I/O network circuitry 210, the programmable circuitry 212, circuitry external to the compute device 202, etc.). For example, in situations where a data consumer requests access to data stored by a remote device (e.g., a network attached storage), the I/O network circuitry 210 implements the TME circuitry 226 and/or any circuitry implemented by the TME circuitry 226. In some examples, the TME circuitry 226 and/or any circuitry implemented by the TME circuitry 226 is implemented in combination with the memory controller circuitry 214. Additionally or alternatively, the TME circuitry 226, any circuitry implemented by the TME circuitry 226, and/or, more generally, the memory controller circuitry 214 may be referred to using different terms. In the example of FIG. 2, the TME circuitry 226 is in communication with the programmable circuitry 212, the VE programmable circuit 216, and the memory 208 (e.g., the first memory 208A, the second memory 208B, the third memory 208C, and the fourth memory 208D).

In the illustrated example of FIG. 2, the VE programmable circuit 216 is in communication with the data provider 204, the memory controller circuitry 214 (e.g., the TME circuitry 226), and the persistent storage 218. In some examples, the VE programmable circuit 216 is in communication with the programmable circuitry 212 (e.g., the user software stack 220, for example, executed from the secure enclave 224). In the example of FIG. 2, the VE programmable circuit 216 is implemented by hardware (e.g., a chiplet, one or more tiles, etc.). For example, the VE programmable circuit 216 may be instantiated (e.g., creating an instance of, bring into being for any length of time, materialize, implement, etc.) by programmable circuitry such as a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc.

Additionally or alternatively, the VE programmable circuit 216 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of the VE programmable circuit 216 of FIG. 2 may, thus, be instantiated at the same or different times. Some or all of the circuitry of the VE programmable circuit 216 of FIG. 2 may be instantiated, for example, in one or more threads executing concurrently on hardware and/or in series on hardware. Moreover, in some examples, some or all of the circuitry of the VE programmable circuit 216 of FIG. 2 may be implemented by microprocessor circuitry executing instructions and/or FPGA circuitry performing operations to implement one or more virtual machines and/or containers.

In the illustrated example of FIG. 2, the VE programmable circuit 216 is implemented by one or more processor cores of a compute device. For example, in a 68-core processor, the VE programmable circuit 216 is implemented by four cores of the processor. In some examples, the VE programmable circuit 216 is implemented by one or more chiplets and/or one or more tiles. In the example of FIG. 2, the VE programmable circuit 216 is an embedded microcontroller running an OS that provides a variety of features and services described herein. For example, the OS of the VE programmable circuit 216 allows an end-user to access one or more components of the VE programmable circuit 216. In the example of FIG. 2, the VE programmable circuit 216 includes at least one example hardware application programming interface (API) 228 and example programmable circuitry 230. One or more of the at least one example hardware API 228 or the example programmable circuitry 230 is implemented by one or more chiplets and/or one or more tiles.

In the illustrated example of FIG. 2, the VE programmable circuit 216 provides a separate compute domain that is not visible to and/or is not usable by the software (e.g., the user software stack 220, the system software stack 222, etc.) running on the programmable circuitry 212. In the example of FIG. 2, the VE programmable circuit 216 is accessible by data providers (e.g., an external device such as the data provider 204 of FIG. 2) in a trusted manner. For example, devices can discover and attest the VE programmable circuit 216 via an in-band and/or out-of-band interface provided by the at least one hardware API 228. In the example of FIG. 2, using the in-band and/or out-of-band interface, a device can create an asymmetric secured connection to the VE programmable circuit 216 using a public key provided by the VE programmable circuit 216. Additionally, a device can interact with the VE programmable circuit 216 to perform certain operations such as establishing access controls for one or more data consumers of a data stream to be provided by the device.

As used herein, in-band refers to utilizing the same channel or medium for both communication and control and/or configuration. Communication over an in-band interface includes utilizing an internet protocol-based (IP-based) communication interface for both (1) transmission of a data stream from the data provider 204 to the compute device 202 and (2) configuration of access controls for the data stream with the VE programmable circuit 216. Additionally, as used herein, out-of-band refers to utilizing a separate channel or medium, in some examples a dedicated channel or medium, distinct from a primary channel or medium of communication. Communication over an out-of-band interface includes utilizing a first communication interface for transmission of a data stream from the data provider 204 to the compute device 202 and a second communication interface (e.g., a dedicated port) for configuration of access controls for the data stream with the VE programmable circuit 216. For example, the second communication interface is separate from the first communication interface.

As described herein, the at least one hardware API 228 can be accessed out-of-band (e.g., via a separate network interfaces) and/or in-band (e.g., via machine state registers). In some examples, the at least one hardware API 228 is implemented by a single multi-function API. Additionally or alternatively, the at least one hardware API 228 is implemented by multiple APIs where each of the APIs has relatively less functionality compared to a single multi-function API. In an example where the at least one hardware API 228 is implemented by multiple APIs, a first API allows the data provider 204 (e.g., a sensor) to receive proof of identity of the VE programmable circuit 216 so the data provider 204 can validate the proof of identity to establish trust as described herein.

Additionally, in an example where the at least one hardware API 228 is implemented by multiple APIs, a second API can be accessed by the data provider 204 to register, with the VE programmable circuit 216, a stream of data that is to be provided for storage in the memory 208 and is intended to be accessible by only the VE programmable circuit 216 and/or one or more designated groups of entities of the compute device 202. For example, via the second API, the data provider 204 can establish a secure channel with the VE programmable circuit 216 using a public key of the VE programmable circuit 216. In the example of FIG. 2, the stream of data (e.g., including one or more data objects) is identified by an identifier such as a universally unique identifier (UUID).

In the illustrated example of FIG. 2, based on registration of a data stream, the data provider 204 provides the VE programmable circuit 216 with a cryptographic key (e.g., a cryptographic asymmetric key) that will be used by the data provider 204 to encrypt one or more data objects sent for storage in the memory 208. In some examples, the cryptographic key is generated by another entity (e.g., the VE programmable circuit 216, a third-party key manager, etc.). In the example of FIG. 2, the cryptographic key is provided via the secure channel established between the data provider 204 and the VE programmable circuit 216. Additionally, based on registration of a data stream, the VE programmable circuit 216 provides the data provider 204 with a memory range in the memory 208 reserved for storage of one or more data objects included in the registered data stream.

In the illustrated example of FIG. 2, the programmable circuitry 230 provides the data provider 204 with the ability to (1) securely store data (e.g., the data object 206) in the memory 208 with one or more encryption keys and (2) control which entities can access the data (e.g., the data object 206) stored in the memory. For example, via the secure channel described above, the data provider 204 can provide an example access control list 232 specifying which entities can access the data object 206 and the extent to which the entities can access the data object 206. In the example of FIG. 2, based on the access control list 232 provided by the data provider 204, the programmable circuitry 230 updates an example data provider mapping table 234 stored in the persistent storage 218.

In the illustrated example of FIG. 2, the persistent storage 218 is implemented by non-volatile memory such as a read-only memory (ROM), a programmable ROM (PROM), an erasable PROM (EPROM), an electrically erasable PROM (EEPROM), ferroelectric random-access memory (RAM), and/or flash memory, among others. While in the illustrated example the persistent storage 218 is illustrated as a single storage, the persistent storage 218 may be implemented by any number and/or type(s) of storages. Furthermore, data stored in the persistent storage 218 may be in any data format such as, for example, binary data, comma delimited data, tab delimited data, structured query language (SQL) structures, etc.

In the illustrated example of FIG. 2, the persistent storage 218 stores the data provider mapping table 234 that maps the data provider 204 to the data object 206, the access control list 232 for the data object 206, and one or more encryption keys with which the data object 206 is encrypted. In some examples, the data provider mapping table 234 also stores the memory range in which the data object 206 is to be stored. As described herein, the data provider 204 can interface with the VE programmable circuit 216 via one or more of the at least one hardware API 228 to provide an encryption key for the data object 206 and/or to define the access control list 232 for the data object 206. As described herein, the access control list 232 specifies one or more data consumers that are permitted to access the data object 206 and the extent to which the one or more data consumers can access the data object 206 (e.g., all of the raw data, associated metadata, etc.).

In the illustrated example of FIG. 2, the data provider 204 is an entity that generates data to be processed by the compute device 202 as described herein. For example, the data provider 204 is a sensor such as an X-ray machine. In some examples, the data provider 204 can be implemented by any other type of sensor such as a pressure sensor (e.g., a blood pressure sensor), a biochemical sensor (e.g., a glucose monitor, a pulse oximeter, a pregnancy test, etc.), an image sensor (e.g., an X-ray machine, an ultrasound machine, a magnetic resonance imaging (MRI) machine, a positron emission tomography (PET) scanner, etc.), a temperature sensor (e.g., a thermometer), and a respiration rate sensor, among others.

In additional or alternative examples, the data provider 204 is implemented by an accelerometer, a light sensor, a sound sensor, a pressure sensor, a camera, a thermal sensor, an electrical field sensor, a chemical sensor, an infrared sensor, or a seismic sensor, among others. In some examples, the data provider 204 is an entity internal to the compute device 202. In such examples, the data provider 204 may be the programmable circuitry 212 (e.g., the user software stack 220, for example, executed from the secure enclave 224).

In the illustrated example of FIG. 2, the memory 208 includes the first memory 208A, the second memory 208B, the third memory 208C, and the fourth memory 208D. For example, one or more of the first memory 208A, the second memory 208B, the third memory 208C, or the fourth memory 208D is implemented by a volatile memory (e.g., a Synchronous Dynamic Random Access Memory (SDRAM), Dynamic Random Access Memory (DRAM), RAMBUS® Dynamic Random Access Memory (RDRAM), etc.) and/or a non-volatile memory (e.g., flash memory). One or more of the first memory 208A, the second memory 208B, the third memory 208C, or the fourth memory 208D may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the memory 208 is illustrated as a multiple memories, the memory 208 may be implemented by a single memory. In additional or alternative examples, the memory 208 may be implemented by any number and/or type(s) of memories. Furthermore, the data stored in the memory 208 may be in any data format such as, for example, binary data, comma delimited data, tab delimited data, SQL structures, etc.

In the illustrated example of FIG. 2, the first memory 208A, the second memory 208B, the third memory 208C, and the fourth memory 208D are implemented externally to the compute device 202. In some examples, one or more of the first memory 208A, the second memory 208B, the third memory 208C, or the fourth memory 208D is implemented internal to the compute device 202 (e.g., as one or more chiplets and/or one or more tiles). In the example of FIG. 2, the first memory 208A, the second memory 208B, the third memory 208C, and the fourth memory 208D are implemented in accordance with a memory interface standard such as a JEDEC standard (e.g., a DDR standard, an mDDR standard, a GDDR standard, etc.) and/or a RAMBUS® standard (e.g., an XDR standard). Additionally, the first memory 208A, the second memory 208B, the third memory 208C, and the fourth memory 208D are implemented in accordance with a memory form factor such as the dual in-line memory module (DIMM) form factor. Other memory form factors are possible such as the universal DIMM (UniDIMM) form factor, the Accelerated Graphics Port (AGP) in-line memory module (AIMM) form factor, the compression attached memory module (CAMM) form factor, the single in-line memory module (SIMM) form factor, and/or the single in-line pin package (SIPP) form factor.

As described herein, the multiple instances of the memory 208 support a multi-channel interface between the memory 208 and the compute device 202. For example, a memory channel refers to a communication path between the memory 208 and the compute device 202. In the example of FIG. 2, the memory 208 supports a quad-channel architecture. Increasing the number of channels (e.g., instances of memory) increases the data rate of communication between the memory 208 and the compute device 202. Additional or alternative architectures may also be supported by the memory 208 such as a dual-channel architecture (e.g., two instances of memory), a triple-channel architecture (e.g., three instances of memory), a hexa-channel architecture (e.g., six instances of memory), an octa-channel architecture (e.g., cight instances of memory), or a dodeca-channel architecture (e.g., 12 instances of memory).

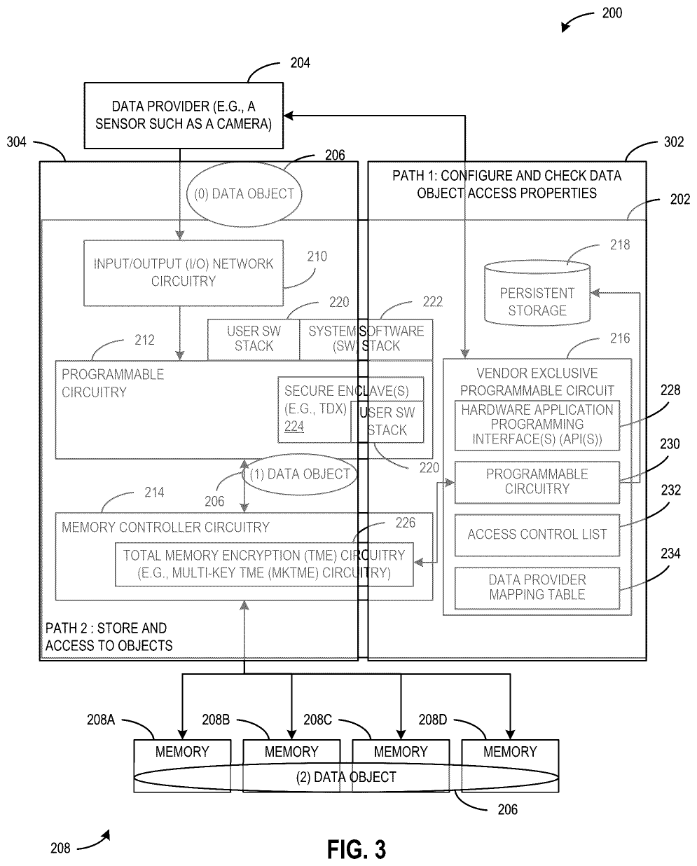

FIG. 3 is a block diagram illustrating a first example communication path 302 for the data provider 204 of FIG. 2 to configure and check access properties of the data object 206 of FIG. 2 and a second example communication path 304 for storage and access of the data object 206. For example, the first communication path 302 allows the data provider 204 to set up one or more secure data lakes in the memory 208 as described herein. In the example of FIG. 3, the VE programmable circuit 216 (e.g., a hardware system computer) provides the first communication path 302 as an in-band interface and/or out-of-band interface that allows the data provider 204 to register a data stream of one or more data objects with the VE programmable circuit 216.

For example, for an out-of-band interface implementation, the compute device 202 includes a dedicated and/or predefined port (e.g., the at least one hardware API 228) to advertise to the data provider 204 that the compute device 202 includes the VE programmable circuit 216. Additionally or alternatively, the out-of-band interface (e.g., the at least one hardware API 228) is implemented as an intelligent platform management interface (IPMI) through which a baseboard management controller (BMC) of the compute device 202 advertises the internet protocol (IP) address and/or port address of the VE programmable circuit 216. Additional or alternative implementations of the out-of-band interface (e.g., the at least one hardware API 228) include a representational state transfer (REST) interface implemented in accordance with the Redfish standard. Based on the IP and/or port address of the VE programmable circuit 216, the data provider 204 can access the VE programmable circuit 216 via the at least one hardware API 228 (e.g., to obtain the public key and/or the provide the access control list 232). In one or more examples, the BMC of the compute device 202 is implemented by the VE programmable circuit 216.

In some examples, the VE programmable circuit 216 loads code (e.g., the OS of the VE programmable circuit 216) from the persistent storage 218 (e.g., flash memory). As such, the VE programmable circuit 216 can be initiated before the OS of the programmable circuitry 212 is started. That is, the power state of the VE programmable circuit 216 is independent of the power state of the programmable circuitry 212. For example, the VE programmable circuit 216 can be enabled and operational while the programmable circuitry 212 and/or other components of the compute device 202 are in a sleep state. Thus, the VE programmable circuit 216 can be operational based on power being applied to the compute device 202 (e.g., regardless of whether the programmable circuitry 212 is operational). Accordingly, the VE programmable circuit 216 can respond to out-of-band communications (e.g., from the data provider 204).

In the illustrated example of FIG. 3, via the first communication path 302, the data provider 204 provides the VE programmable circuit 216 with cryptographic means (e.g., a key) by which the data provider 204 is to secure data to be stored by the memory 208 (e.g., via the second communication path 304). Additionally, via the first communication path 302, the data provider 204 sets up (e.g., establishes) access control lists for data lakes set up in the memory 208. As such, via the first communication path 302, the data provider 204 can create a secure channel (e.g., the second communication path 304) with the compute device 202 through which the data provider 204 can provide encrypted data that can only be accessed by designated entities based on access controls managed by the VE programmable circuit 216 and/or software executed by the programmable circuitry 230 of the VE programmable circuit 216 (e.g., for a specific purpose).

In the illustrated example of FIG. 3, the second communication path 304 provides one or more software stacks resident on the compute device 202 with access to data objects provided by the data provider 204. For example, the user software stack 220, the system software stack 222, and/or software executed by the programmable circuitry 230 can access one or more secured data objects stored in the memory 208 based on one or more access control lists defined for the one or more data objects via the first communication path 302. As described herein, the VE programmable circuit 216 provides a separate compute domain that controls access to data stored via the secure channel (e.g., the second communication path 304). For example, the programmable circuitry 230 of the VE programmable circuit 216 can access the data object 206 to perform specific processing and/or manage whether to allow access to the data object 206 by other entities (e.g., software executed by the programmable circuitry 212) based on the access control list 232 defined by the data provider 204 and stored in the data provider mapping table 234. Example processing that can be performed by the programmable circuitry 230 and/or the programmable circuitry 212 includes training ML/AI models to use information provided by the data provider 204 to apply certain management policies within the compute device 202.

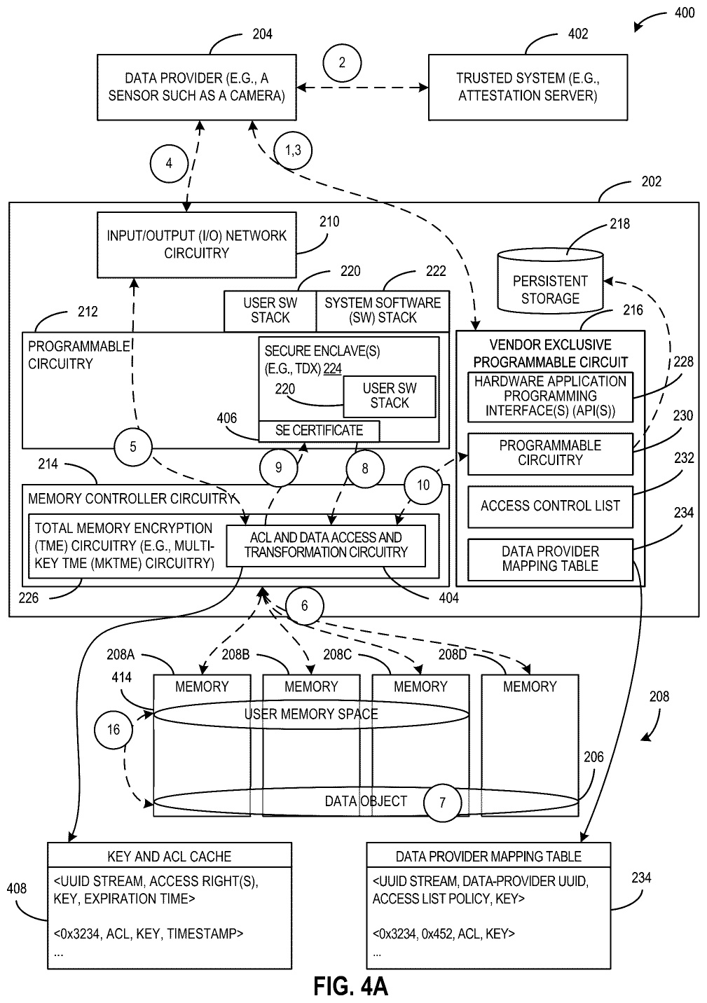

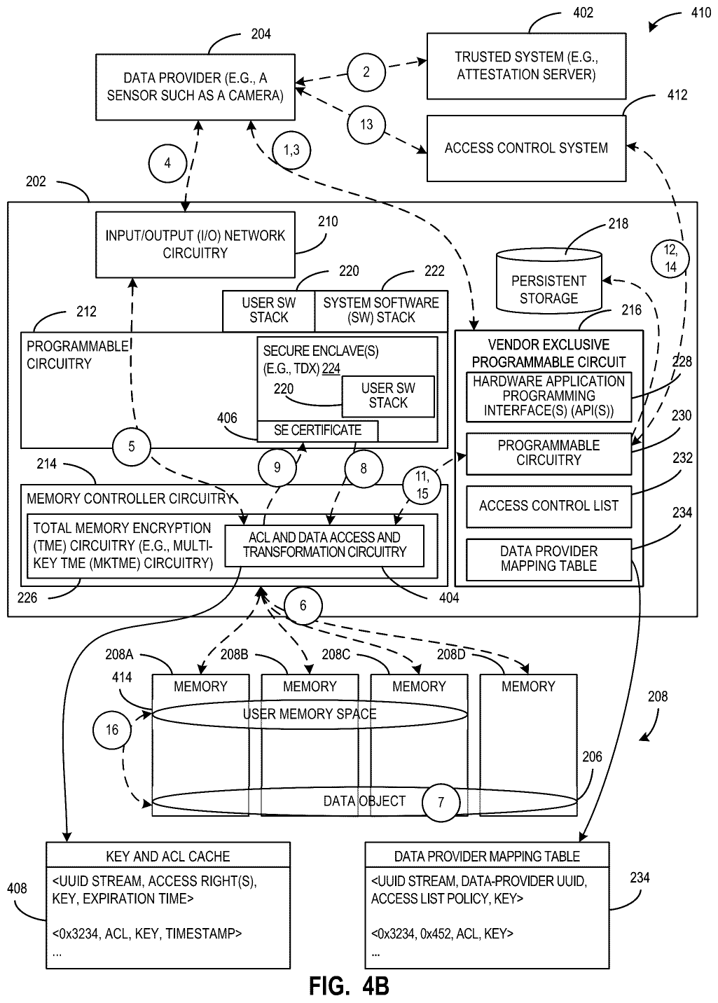

FIG. 4A is a block diagram of an example operation sequence 400 to configure access properties of the data object 206 of FIG. 2, store the data object 206, and control access to the data object 206. In the example of FIG. 4A, based on a first operation, the data provider 204 communicates out-of-band with the VE programmable circuit 216 to request proof of identity. For example, the data provider 204 discovers a public key of the VE programmable circuit 216 via the at least one hardware API 228 of the VE programmable circuit 216. In the example of FIG. 4A, the programmable circuitry 230 advertises the public key of the VE programmable circuit 216 via the at least one hardware API 228 and the data provider 204 discovers the public key via the at least one hardware API 228. For example, the programmable circuitry 230 is to cause interface circuitry (e.g., the at least one hardware API 228) to advertise the public key of the VE programmable circuit 216. In some examples, the VE programmable circuit 216 advertises a certificate including the public key.

Additionally or alternatively, based on the first operation, the data provider 204 communicates in-band with the VE programmable circuit 216 to request proof of identity. For example, the data provider 204 discovers the public key and/or the certificate of the VE programmable circuit 216 via at least one machine state register of the at least one hardware API 228. That is, the data provider 204 accesses the at least one machine state register of the at least one hardware API 228 via at least one of the I/O network circuitry 210 or the programmable circuitry 212. In other examples, accessing the VE programmable circuit 216 out-of-band provides the data provider 204 with a greater degree of security than accessing the VE programmable circuit 216 in-band (e.g., because the data provider 204 does not interact with generally accessible components of the compute device 202 such as the I/O network circuitry 210 and/or the programmable circuitry 212).

In the illustrated example of FIG. 4A, based on a second operation, the data provider 204 validates the identity of the VE programmable circuit 216. For example, the data provider 204 validates the identity of the VE programmable circuit 216 with an example trusted system 402. In the example of FIG. 4A, the trusted system 402 is an attestation service that can validate a signature of a timestamp and a nonce value (e.g., generated by the VE programmable circuit 216 and provided by the data provider 204) using the public key of the VE programmable circuit 216 to provide the data provider 204 with an assurance that the VE programmable circuit 216 is a legitimate entity (e.g., not a malicious entity). Example attestation services to implement the trusted system 402 include elliptic curve digital signature algorithm (ECDSA) attestation, Intel® Enhanced Privacy ID (EPID) attestation, and Microsoft Azure Attestation, among others.

In the illustrated example of FIG. 4A, based on a third operation, the data provider 204 and the VE programmable circuit 216 create an asymmetric secured connection (e.g., the first communication path 302) via the at least one hardware API 228. Via the asymmetric secured connection (e.g., the first communication path 302), the data provider 204 provides the programmable circuitry 230 with an encrypted UUID for a data stream. In this manner, the data provider 204 initiates registration of the data stream with the VE programmable circuit 216. As part of registration of the data stream, the data provider 204 also provides an encrypted UUID for the data provider 204, an encrypted cryptographic key for the data stream, and an encrypted version of the access control list 232 via the asymmetric secured connection (e.g., the first communication path 302). In some examples, the data provider 204 provides an encrypted identifier (e.g., a UUID, an address, a pointer, etc.) of an entity (e.g., a secure external entity, a trusted external entity, etc.) from which the VE programmable circuit 216 can access the access control list 232 instead of providing the access control list 232. In this manner, the data provider 204 can update access controls with the entity at runtime and can request that the VE programmable circuit 216 consult the entity (e.g., a trusted external service) to check access controls for a data object every time a software stack requests access to the data object. In the example of FIG. 4A, the encrypted UUID for the data stream, the encrypted UUID for the data provider 204, the encrypted cryptographic key for the data stream, the encrypted version of the access control list 232, and/or the encrypted identifier of the entity at which the VE programmable circuit 216 can access the access control list 232 are encrypted with the public key of the VE programmable circuit 216.

In the illustrated example of FIG. 4A, based on receiving the UUID for the data stream, the programmable circuitry 230 creates an entry in the data provider mapping table 234 for the data stream. In the example of FIG. 4A, the programmable circuitry 230 stores the UUID for the data stream, the UUID for the data provider 204, the cryptographic key for the data stream, and the access control list 232 in the entry of the data provider mapping table 234 for the data stream. As described herein, the cryptographic key can be used to access a portion of the data stream that is to be stored in the memory 208. In the example of FIG. 4A, the cryptographic key is implemented as a symmetric key to facilitate quicker access to secured data by data consumers (e.g., as compared to other types of keys). Additionally or alternatively, the cryptographic key is an asymmetric key. In some examples, the cryptographic key is a homomorphic based key.

As described herein, the data provider 204 also provides the access control list 232 to specify which entities can access one or more data objects (e.g., the data object 206) of the data stream and the extent to which the entities can access the one or more data objects (e.g., the data object 206) of the data stream. For example, the access control list 232 specifies which software applications (e.g., having a certain certificate) are permitted to access a limited portion of (e.g., certain regions such as metadata) of the one or more data objects stored for the data stream. Additionally, for example, the access control list 232 specifies which software application (e.g., having a certain certificate) are permitted to access all of the raw data of the one or more data objects stored for the data stream. In the example of FIG. 4A, as part of the registration of the data stream, the VE programmable circuit 216 provides the data provider 204 with a memory range in the memory 208 where the data stream is to be stored. For example, the memory range is reserved in memory (e.g., the memory 208) for the encrypted data object by the VE programmable circuit 216. In the example of FIG. 4A, the communication including the identified memory range (e.g., from the VE programmable circuit 216 to the data provider 204) is encrypted with the public key of the VE programmable circuit 216.

Based on registering a data stream with the VE programmable circuit 216, the data provider 204 can provide one or more data objects (e.g., the data object 206) for storage in the memory 208 with trust. In the example of FIG. 4A, the data provider 204 connects to the I/O network circuitry 210 of the compute device 202 to communicate with the programmable circuitry 212 and/or software executed by the programmable circuitry 212. For example, the data provider 204 connects to the I/O network circuitry 210 to communicate with the user software stack 220 and/or the system software stack 222.

In the illustrated example of FIG. 4A, based on a fourth operation, the data provider 204 generates a data stream (e.g., the data object 206) identified by the UUID registered with the VE programmable circuit 216 in the data provider mapping table 234. Additionally, the data stream (e.g., the data object 206) is encrypted with the cryptographic key registered with the VE programmable circuit 216 in the data provider mapping table 234. In the example of FIG. 4A, when providing the data stream (e.g., the data object 206) for storage in the memory 208, the data provider 204 includes the memory range provided by the VE programmable circuit 216 during registration of the data stream (e.g., the data object 206).

In the illustrated example of FIG. 4A, based on a fifth operation, software executed by the programmable circuitry 212 forwards the data stream (e.g., the data object 206) to the memory controller circuitry 214. In the example of FIG. 4A, based on a sixth operation, the memory controller circuitry 214 causes storage of the data stream (e.g., the data object 206) in the memory range specified by the data provider 204. For example, the memory range for storage of the data stream (e.g., the data object 206) in the memory 208 is divided across one or more of the first memory 208A, the second memory 208B, the third memory 208C, or the fourth memory 208D.

In the illustrated example of FIG. 4A, based on a seventh operation, the data stream (e.g., the data object 206) is at rest (e.g., stored) in the memory 208. Based on storage of the data stream in the memory 208, software running on the programmable circuitry 212 and/or the programmable circuitry 230 can access one or more data objects, for example, using the UUID of the data stream. In the example of FIG. 4A, based on an eighth operation, the user software stack 220 requests access to the data object 206, for example, using the UUID of the data object 206. Based on the user software stack 220 requesting access to the data object 206, the TME circuitry 226 determines whether the user software stack 220 is permitted to access the data object 206.

For example, based on a ninth operation, example access control list (ACL) and data access and transformation (DAAT) circuitry 404 of the TME circuitry 226 accesses an example certificate 406 of the user software stack 220. In the example of FIG. 4A, the ACL and DAAT circuitry 404 is implemented by one or more chiplets and/or one or more tiles. Also, in the example of FIG. 4A, the certificate 406 is a secure enclave (SE) certificate that includes an identity of the user software stack 220, a name of a certificate authority that issued the SE certificate, and an expiration date of the SE certificate. For example, the certificate authority that issued the certificate 406 is the secure enclave 224.

In the illustrated example of FIG. 4A, based on the certificate 406, the ACL and DAAT circuitry 404 determines an identity of the user software stack 220. In the example of FIG. 4A, based on a tenth operation, the ACL and DAAT circuitry 404 provides the UUID of the data object 206 (e.g., received from the user software stack 220) to the programmable circuitry 230 of the VE programmable circuit 216. Based on the UUID, the programmable circuitry 230 access the data provider mapping table 234 to determine if the data provider mapping table 234 includes an access control list associated with the UUID.

In the illustrated example of FIG. 4A, based on determining that the data provider mapping table 234 includes an access control list associated with the UUID of the data object 206 (e.g., the access control list 232), the programmable circuitry 230 provides the ACL and DAAT circuitry 404 with access to a portion of the entry of the data provider mapping table 234 corresponding to the UUID. For example, the programmable circuitry 230 copies a portion of the entry of the data provider mapping table 234 corresponding to the UUID to an example key and access control list cache 408 of the ACL and DAAT circuitry 404. In the example of FIG. 4A, the programmable circuitry 230 copies the UUID for the data object 206, one or more access controls corresponding to the user software stack 220 for the data object 206, the cryptographic key for the data object 206, and a timestamp indicative of a time at which access to the data object 206 by the user software stack 220 expires. For example, the time at which access to the data object 206 by the user software stack 220 expires (e.g., an expiration time) is based on the access control list 232 provided by the data provider 204. After the expiration time is reached, the ACL and DAAT circuitry 404 accesses the access control list 232 from the data provider mapping table 234 to determine if any of the one or more access controls corresponding to the user software stack 220 for the data object 206 have been updated.

As described above, in some examples, the data provider 204 provides the VE programmable circuit 216 with an encrypted identifier of an entity from which the VE programmable circuit 216 can access the access control list 232. For example, FIG. 4B is a block diagram of an example operation sequence 410 to configure access properties of the data object 206 of FIG. 2 and control access to the data object 206 based on communication with an example access control system 412. In the example of FIG. 4B, upon receipt of a request to access the data object 206 (e.g., based on the eighth and ninth operations of FIG. 4A), the ACL and DAAT circuitry 404 provides, based on an eleventh operation, the VE programmable circuit 216 with an identifier (e.g., the UUID) of the data object 206 and the certificate 406 (e.g., provided by the user software stack 220 based on the request).

In the illustrated example of FIG. 4B, based on a twelfth operation, the VE programmable circuit 216 communicates the identifier of the data object 206 and the certificate 406 to the access control system 412 (e.g., the entity identified by the data provider 204) to determine whether the user software stack 220 is permitted to access the data object 206. For example, based on receipt of the identifier of the data object 206, the programmable circuitry 230 consults the data provider mapping table 234 to determine an access control policy for the data object 206. That is, in some examples, the data provider mapping table 234 stores access control policies for corresponding data objects and/or data streams. For example, an access control policy indicates whether an access control list for a data object is stored locally (e.g., in the persistent storage 218) and/or whether the access control system 412 is to be consulted to determine the access control list for the data object. Based on the access control policy for the data object 206 indicating that the access control system 412 is to be consulted, the programmable circuitry 230 causes one or more of the at least one hardware API 228 to communicate the identifier of the data object 206 and the certificate 406 to the access control system 412.

As described above, the data provider 204 can update access controls with the access control system 412 at runtime. For example, based on a thirteenth operation, the data provider 204 communicates with the access control system 412 to adjust access properties (e.g., permissions for access) of the data object 206 on-the-fly (e.g., at runtime). In the example of FIG. 4B, the access control system 412 is an external service that can manage access controls for data objects. In some examples, the access control system 412 is provided by the same entity that provides the VE programmable circuit 216. Additionally or alternatively, the access control system 412 and the VE programmable circuit 216 are provided by different entities.

In the illustrated example of FIG. 4B, based on a fourteenth operation, the access control system 412 responds to the communication from the VE programmable circuit 216. For example, the access control system 412 sends the VE programmable circuit 216 a current version of the access control list 232 for the data object 206. In this manner, the access control system 412 notifies the VE programmable circuit 216 whether and to what extent to permit the user software stack 220 to access the data object 206. Based on a fifteenth operation, the VE programmable circuit 216 responds to the request forwarded by the ACL and DAAT circuitry 404. For example, based on a response from the access control system 412 that indicates that the user software stack 220 is permitted to access the data object 206, the programmable circuitry 230 copies data into the key and access control list cache 408 of the ACL and DAAT circuitry 404 as described above. As described in FIG. 4B, the VE programmable circuit 216 does not maintain a static access control list and control of access to a data object is performed at runtime by the access control system 412 (e.g., the entity designated by the data provider 204 during registration of a data stream).

Returning to FIG. 4A, the key and access control list cache 408 is implemented by cache memory such as static RAM (SRAM). For example, the key and access control list cache 408 is implemented as at least one of level one (L1) cache, level two (L2) cache, or level three (L3) cache. In the example of FIG. 4A, the ACL and DAAT circuitry 404 checks the identity of the user software stack 220 retrieved from the certificate 406 against the key and access list cache 408. For example, the ACL and DAAT circuitry 404 cross references the identity of the user software stack 220 against the key and access list cache 408 to determine the one or more access controls for the user software stack 220 stored in the key and access list cache 408. In this manner, the ACL and DAAT circuitry 404 utilizes the certificate 406 to attest and validate the access rights of the user software stack 220. Additionally or alternatively, the ACL and DAAT circuitry 404 determines, based on the certificate 406, whether the user software stack 220 is being run from a TEE. In this manner, the ACL and DAAT circuitry 404 can verify whether software requesting access to data is being run from a secure and trusted environment. Based on the one or more access controls for the user software stack 220 stored in the key and access list cache 408, the ACL and DAAT circuitry 404 determines whether and to what extent the user software stack 220 is permitted to access the data object 206.

In the illustrated example of FIG. 4A, based on a sixteenth operation, the ACL and DAAT circuitry 404 provides the user software stack 220 with access to a portion of the data object 206 if the ACL and DAAT circuitry 404 determines that the user software stack 220 is permitted to access the portion of the data object 206. For example, if the ACL and DAAT circuitry 404 determines that the user software stack 220 is permitted to access a portion of the data object 206, the ACL and DAAT circuitry 404 decrypts the data object 206 and extracts the portion of the data object 206 to which the user software stack 220 is permitted access. Additionally, the ACL and DAAT circuitry 404 copies the portion of the data object 206 to an example user memory space 414 to which the user software stack 220 has access. For example, the ACL and DAAT circuitry 404 refers to the certificate 406, which includes a pointer to the user memory space 414, and utilizes the pointer to determine the address of the user memory space 414.

In the illustrated example of FIG. 4A, based on processing the portion of the data object, the user software stack 220 causes storage of an additional data object in the user memory space 414. In some examples, the user software stack 220 establishes a secure channel with the VE programmable circuit 216, as described in FIG. 3, to establish access controls to manage which data consumers can access the additional data object and the extent to which the data consumers can access the additional data object. Additionally, in some examples, the user software stack 220 and/or other data consumers having access to the data object 206 are not permitted to overwrite or erase the data object 206. As such, access to the data object 206 by one or more data consumers will not cause coherency problems.

As described above, disclosed examples provide data providers with a form and/or level of trust. For example, an entity (e.g., a data provider) may leverage different forms and/or levels of trust when determining access privileges for a data consumer. Such different forms and/or levels of trust are also referred to herein as trust attributes. Such trust attributes can be utilized individually or in different combinations to achieve one or more overall trust goals associated with management of and/or operation of a compute device such as a tile and/or a chiplet.

For example, the VE programmable circuit 216 may implement one or more trust attributes related to device security (e.g., also referred to as device security trust attributes) as specified by the data provider 204 to verify the authenticity and/or integrity of one or more tiles, one or more chiplets included in the compute device 202 (e.g., the programmable circuitry 212). Additionally or alternatively, the VE programmable circuit 216 may implement one or more trust attributes related to client security (e.g., also referred to as client security trust attributes) as specified by the data provider 204 to verify the authenticity and/or integrity of one or more client devices, one or more of applications, etc., that request access to one or more data objects stored in the memory 208. Additionally or alternatively, the VE programmable circuit 216 may implement one or more trust attributes related to privilege verification (e.g., also referred to as privilege verification trust attributes) as specified by the data provider 204 to verify that a tile, chiplet, client, etc., has appropriate authorization to be granted access to one or more data objects stored in the memory 208.

In some examples, the trust attributes associated with one or more tiles, one or more chiplets, one or more client devices, one or more applications, etc. are output as values, such as one or more numeric values, one or more text values, etc., that can be evaluated through one or more operations (e.g., comparisons, concatenations, summations, differences, etc.). For example, two or more different trust attributes can be combined to develop an overall trust value or score for an entity such as one or more tiles, one or more chiplets, one or more client devices, one or more applications, etc. In some examples, the values of individual trust attributes and/or different combinations of trust attributes can be used to develop several composite trust value(s) or score(s) (e.g., at different hierarchical levels) for one or more tiles, one or more chiplets, one or more client devices, one or more applications, etc.

Given the different forms of trust attributes provided by herein, one or more of such trust attributes may also be referred to using other terminology. For example, trust attributes may also refer to as competence attribute(s) and/or compliance attribute(s) that quantify which entities (e.g., one or more tiles, one or more chiplets, one or more client devices, one or more applications, etc.) can access one or more data objects stored in the memory 208 and the extent to which the entities can access the one or more data objects (e.g., for a given task or set of tasks such as the competence and/or compliance of an artificial intelligence model obtained by and/or executed by a given tile and/or chiplet). In some examples, one or more trust attributes may be referred to as integrity attribute(s), assurance attribute(s), validation/validity attribute(s), privacy attribute(s), reliability attribute(s), credibility attribute(s), safety attribute(s), explainability attribute(s), trustworthiness attribute(s), etc.

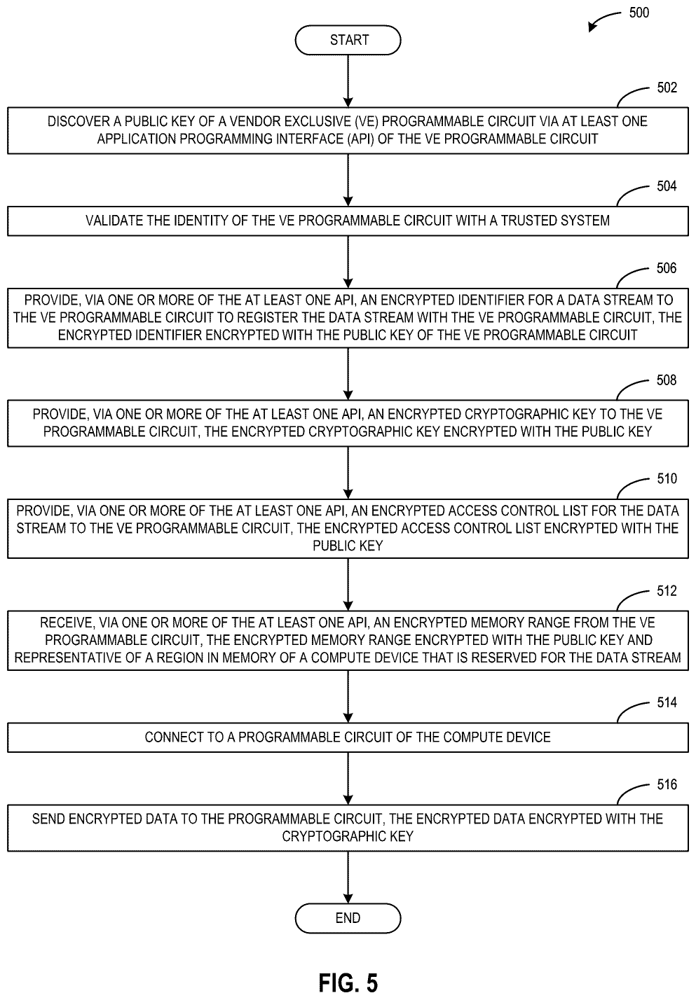

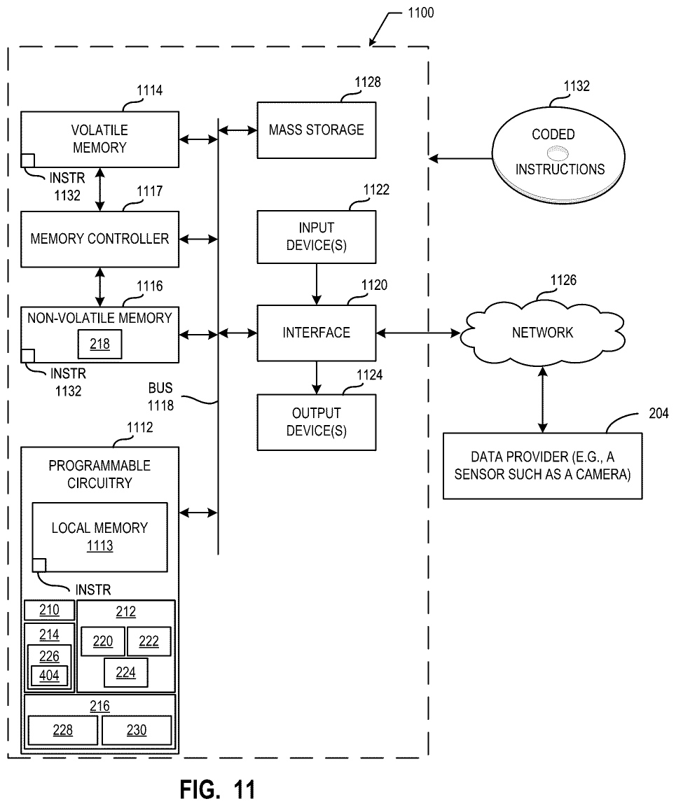

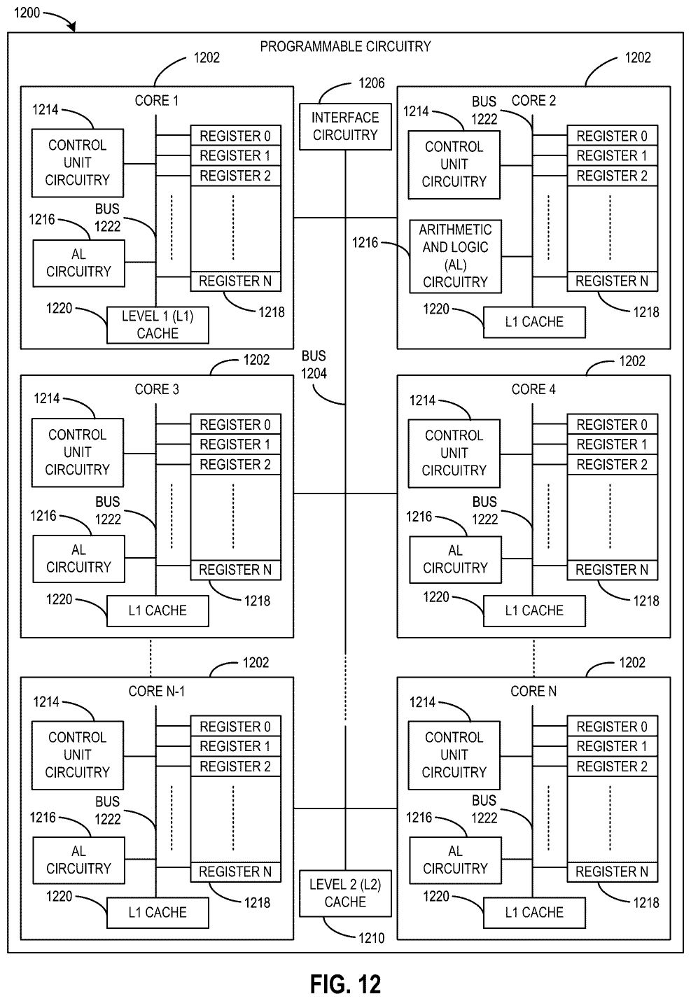

In some examples, the data provider 204 is instantiated by programmable circuitry executing data provider instructions and/or configured to perform operations such as those represented by the flowchart(s) of FIG. 5. In some examples, the data provider 204 includes means for providing data. For example, the means for determining may be implemented by the data provider 204. In some examples, the data provider 204 may be instantiated by programmable circuitry such as the example programmable circuitry 1112 of FIG. 11. For instance, the data provider 204 may be instantiated by the example microprocessor 1200 of FIG. 12 executing machine-executable instructions such as those implemented by at least blocks 502, 504, 506, 508, 510, 512, 514, and 516 of FIG. 5.

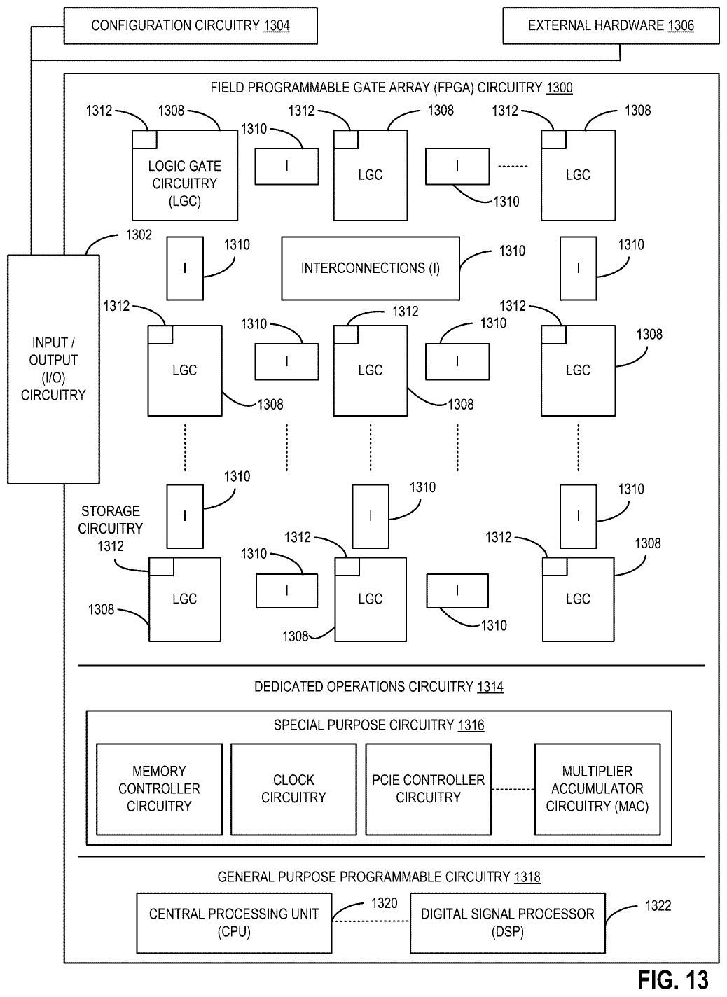

In some examples, the data provider 204 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the data provider 204 may be instantiated by any other combination of hardware, software, and/or firmware. For example, the data provider 204 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

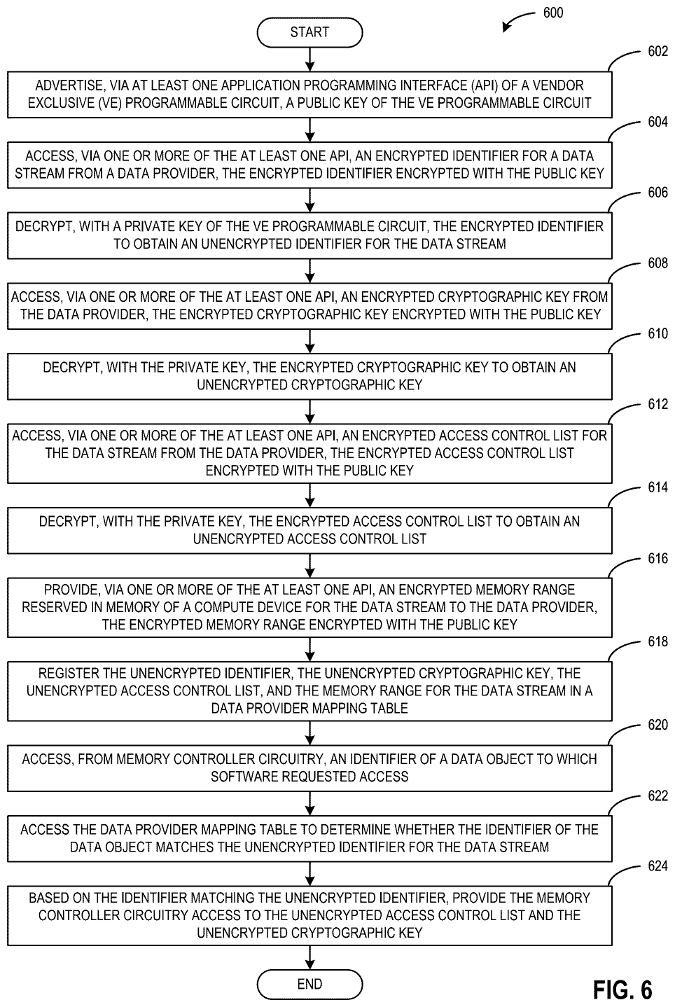

In some examples, the programmable circuitry 230 is instantiated by programmable circuitry executing access control management instructions and/or configured to perform operations such as those represented by the flowchart(s) of FIG. 6. In some examples, the VE programmable circuit 216 includes means for managing an access control list for an encrypted data object. For example, the means for managing may be implemented by the programmable circuitry 230. In some examples, the programmable circuitry 230 may be instantiated by programmable circuitry such as the example programmable circuitry 1112 of FIG. 11. For instance, the programmable circuitry 230 may be instantiated by the example microprocessor 1200 of FIG. 12 executing machine-executable instructions such as those implemented by at least blocks 602, 604, 606, 608, 610, 612, 614, 616, 618, 620, 622, and 624 of FIG. 6.

In some examples, the programmable circuitry 230 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the programmable circuitry 230 may be instantiated by any other combination of hardware, software, and/or firmware. For example, the programmable circuitry 230 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

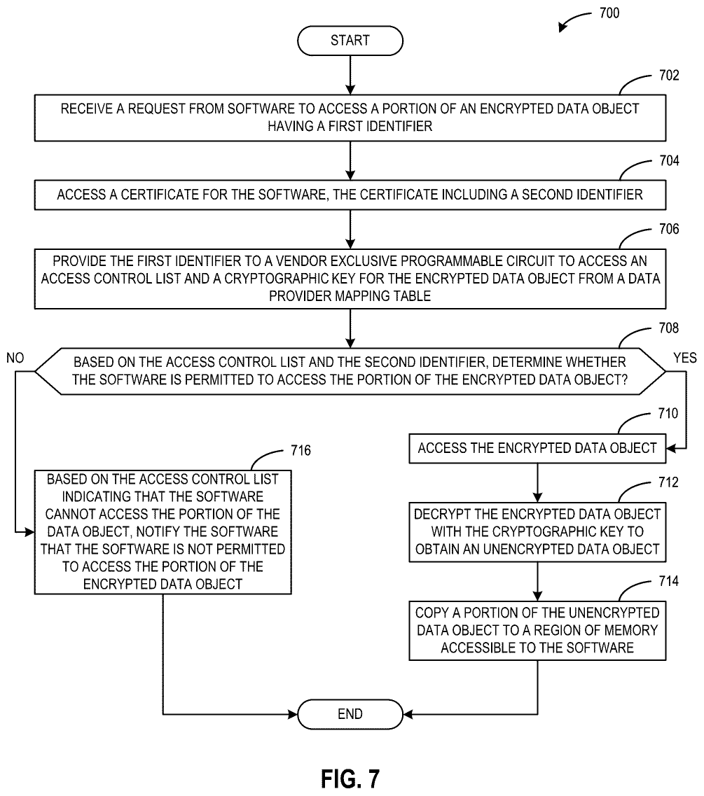

In some examples, the ACL and DAAT circuitry 404, and/or, more generally, the TME circuitry 226 is instantiated by programmable circuitry executing access control instructions and/or configured to perform operations such as those represented by the flowchart(s) of FIG. 7. In some examples, the memory controller circuitry 214 includes means for controlling access to an encrypted data object. For example, the means for controlling may be implemented by the ACL and DAAT circuitry 404, and/or, more generally, the TME circuitry 226. In some examples, the ACL and DAAT circuitry 404, and/or, more generally, the TME circuitry 226 may be instantiated by programmable circuitry such as the example programmable circuitry 1112 of FIG. 11. For instance, the ACL and DAAT circuitry 404, and/or, more generally, the TME circuitry 226 may be instantiated by the example microprocessor 1200 of FIG. 12 executing machine-executable instructions such as those implemented by at least blocks 702, 704, 706, 708, 710, 712, 714, and 716 of FIG. 7.

In some examples, the ACL and DAAT circuitry 404, and/or, more generally, the TME circuitry 226 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the ACL and DAAT circuitry 404, and/or, more generally, the TME circuitry 226 may be instantiated by any other combination of hardware, software, and/or firmware. For example, the ACL and DAAT circuitry 404, and/or, more generally, the TME circuitry 226 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

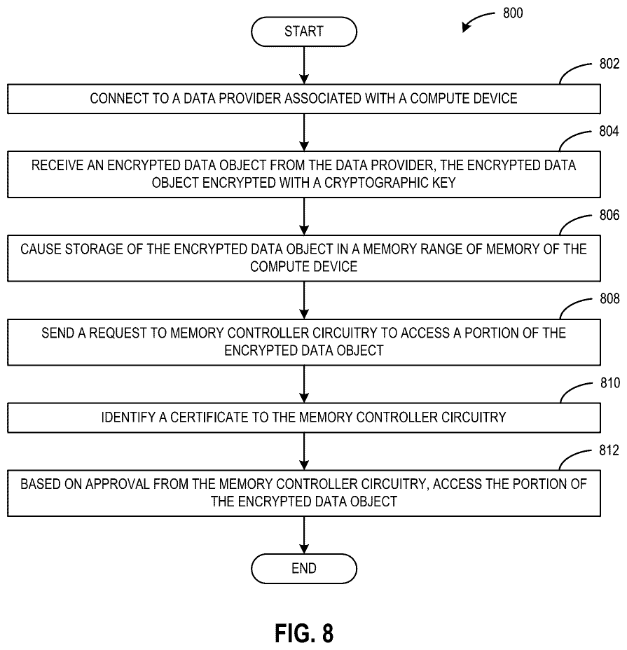

In some examples, the user software stack 220 is instantiated by programmable circuitry executing application instructions and/or configured to perform operations such as those represented by the flowchart(s) of FIG. 8. In some examples, the programmable circuitry 212 includes means for requesting access to an encrypted data object. For example, the means for requesting may be implemented by the user software stack 220. In some examples, the user software stack 220 may be instantiated by programmable circuitry such as the example programmable circuitry 1112 of FIG. 11. For instance, the user software stack 220 may be instantiated by the example microprocessor 1200 of FIG. 12 executing machine-executable instructions such as those implemented by at least blocks 802, 804, 806, 808, 810, and 812 of FIG. 8.

In some examples, the user software stack 220 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the user software stack 220 may be instantiated by any other combination of hardware, software, and/or firmware. For example, the user software stack 220 may be implemented by at least one or more hardware circuits (e.g., programmable circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the compute device 202 of FIGS. 2-4B is illustrated in FIGS. 2-4B, one or more of the elements, processes, and/or devices illustrated in FIGS. 2-4B may be combined, divided, re-arranged, omitted, eliminated, and/or implemented in any other way. Further, the example I/O network circuitry 210, the example user software stack 220, the example system software stack 222, the example secure enclave 224, and/or, more generally, the example programmable circuitry 212, the example ACL and DAAT circuitry 404, the example TME circuitry 226, and/or, more generally, the example memory controller circuitry 214, the at least one example hardware API 228, the example programmable circuitry 230, and/or, more generally, the example VE programmable circuit 216, the example persistent storage 218, and/or, more generally, the example compute device 202 of FIGS. 2-4B, may be implemented by hardware alone or by hardware in combination with software and/or firmware. Thus, for example, any of the example I/O network circuitry 210, the example user software stack 220, the example system software stack 222, the example secure enclave 224, and/or, more generally, the example programmable circuitry 212, the example ACL and DAAT circuitry 404, the example TME circuitry 226, and/or, more generally, the example memory controller circuitry 214, the at least one example hardware API 228, the example programmable circuitry 230, and/or, more generally, the example VE programmable circuit 216, the example persistent storage 218, and/or, more generally, the example compute device 202 of FIGS. 2-4B, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example compute device 202 of FIGS. 2-4B may include one or more elements, processes, and/or devices in addition to, or instead of, those illustrated in FIGS. 2-4B, and/or may include more than one of any or all of the illustrated elements, processes, and devices.

Flowchart(s) representative of example machine-readable instructions, which may be executed by programmable circuitry to implement and/or instantiate the compute device 202 of FIGS. 2-4B and/or representative of example operations which may be performed by programmable circuitry to implement and/or instantiate the compute device 202 of FIGS. 2-4B, are shown in FIGS. 6-8. Additionally, a flowchart representative of example machine-readable instructions, which may be executed by programmable circuitry to implement and/or instantiate the data provider 204 of FIGS. 2-4B and/or representative of example operations which may be performed by programmable circuitry to implement and/or instantiate the data provider 204 of FIGS. 2-4B, is shown in FIG. 5. The machine-readable instructions may be one or more executable programs or portion(s) of one or more executable programs for execution by programmable circuitry such as the programmable circuitry 1112 shown in the example programmable circuitry platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 5-8, many other methods of implementing the example compute device 202 and/or the example data provider 204 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU and/or an FPGA. The programmable circuitry may include one or more CPUs and/or one or more FPGAs located in the same package (e.g., the same integrated circuit (IC) package or in two or more separate housings), one or more CPUs and/or one or more FPGAs in a single machine, multiple CPUs and/or FPGAs distributed across multiple servers of a server rack, and/or multiple CPUs and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5-8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by example programmable circuitry to implement the data provider 204 of FIGS. 2-4B. The example machine-readable instructions and/or the example operations 500 of FIG. 5 begin at block 502, at which the data provider 204 discovers a public key of the VE programmable circuit 216 via at least one API of the VE programmable circuit 216. For example, the data provider 204 discovers a public key of the VE programmable circuit 216 via the at least one hardware API 228.

In the illustrated example of FIG. 5, at block 504, the data provider 204 validates the identity of the VE programmable circuit 216 with the trusted system 402. Based on validating the identity of the VE programmable circuit 216, the data provider 204 creates, via one or more of the at least one API (e.g., the at least one hardware API 228), an asymmetric secured connection with the VE programmable circuit 216. For example, the data provider 204 utilizes the public key of the VE programmable circuit 216 to encrypt data communicated to the VE programmable circuit 216 via one or more of the at least one API (e.g., the at least one hardware API 228). As such, the VE programmable circuit 216 can decrypt the encrypted data utilizing a private key of the VE programmable circuit 216 as described herein.

In the illustrated example of FIG. 5, at block 506, the data provider 204 provides, via one or more of the at least one API (e.g., the at least one hardware API 228), an encrypted identifier for a data stream to the VE programmable circuit 216 to register the data stream with the VE programmable circuit 216. For example, the encrypted identifier is encrypted with the public key of the VE programmable circuit 216. In the example of FIG. 5, at block 508, the data provider 204 provides, via one or more of the at least one API (e.g., the at least one hardware API 228), an encrypted cryptographic key to the VE programmable circuit 216. For example, the encrypted cryptographic key is encrypted with the public key of the VE programmable circuit 216.

In the illustrated example of FIG. 5, at block 510, the data provider 204 provides, via one or more of the at least one API (e.g., the at least one hardware API 228), an encrypted access control list for the data stream to the VE programmable circuit 216. For example, the encrypted access control list is encrypted with the public key of the VE programmable circuit 216. In the example of FIG. 5, at block 512, the data provider 204, via one or more of the at least one API (e.g., the at least one hardware API 228), receives an encrypted memory range from the VE programmable circuit 216. For example, the memory range is contained in a communication that is encrypted with the public key of the VE programmable circuit 216. Additionally, for example, the encrypted memory range represents a reserved region in the memory 208 of the compute device 202 for storage of the data stream.

In the illustrated example of FIG. 5, at block 514, the data provider 204 connects to a programmable circuit of the compute device 202. For example, the data provider 204 connects to the programmable circuitry 212 via the I/O network circuitry 210. In the example of FIG. 5, at block 516, the data provider 204 sends data to the programmable circuit where the data is encrypted with the cryptographic key. As such, the data provider 204 sends the access control list for the data stream to the compute device 202 via a first communication channel (e.g., one or more of the at least one hardware APIs 228) and sends encrypted data to the compute device 202 via a second communication channel (e.g., the I/O network circuitry 210). Similarly, the compute device 202 obtains the access control list via first interface circuitry (e.g., one or more of the at least one hardware APIs 228) and obtains encrypted data via second interface circuitry separate from the first interface circuitry (e.g., the I/O network circuitry 210).

FIG. 6 is a flowchart representative of example machine-readable instructions and/or example operations 600 that may be executed, instantiated, and/or performed by example programmable circuitry to implement the VE programmable circuit 216 of FIGS. 2-4B. The example machine-readable instructions and/or the example operations 600 of FIG. 6 begin at block 602, at which the programmable circuitry 230 advertises, via at least one API of the VE programmable circuit 216, a public key of the VE programmable circuit 216. For example, the programmable circuitry 230 advertises the public key of the VE programmable circuit 216 via the at least one hardware API 228.

In the illustrated example of FIG. 6, based on a data provider (e.g., the data provider 204) validating the identity of the VE programmable circuit 216, the VE programmable circuit 216 creates, via one or more of the at least one API (e.g., the at least one hardware API 228), an asymmetric secured connection with the data provider. For example, the data provider 204 utilizes the public key of the VE programmable circuit 216 to encrypt data communicated to the VE programmable circuit 216 via one or more of the at least one API (e.g., the at least one hardware API 228). As such, the VE programmable circuit 216 can decrypt the encrypted data utilizing a private key of the VE programmable circuit 216 as described herein.

In the illustrated example of FIG. 6, at block 604, the programmable circuitry 230 accesses, via one or more of the at least one API (e.g., the at least one hardware API 228), an encrypted identifier for a data stream from a data provider. For example, the encrypted identifier is encrypted with the public key of the VE programmable circuit 216. In the example of FIG. 6, at block 606, the programmable circuitry 230 decrypts, with a private key of the VE programmable circuit 216, the encrypted identifier to obtain an unencrypted identifier for the data stream. At block 608, the programmable circuitry 230 accesses, via one or more of the at least one API (e.g., the at least one hardware API 228), an encrypted cryptographic key from the data provider. For example, encrypted cryptographic key is encrypted with the public key of the VE programmable circuit 216.

In the illustrated example of FIG. 6, at block 610, the programmable circuitry 230 decrypts, with the private key of the VE programmable circuit 216, the encrypted cryptographic key to obtain an unencrypted cryptographic key. In the example of FIG. 6, at block 612, the programmable circuitry 230 accesses, via one or more of the at least one API (e.g., the at least one hardware API 228), an encrypted access control list for the data stream from the data provider. For example, the encrypted access control list is encrypted with the public key of the VE programmable circuit 216. At block 614, the programmable circuitry 230 decrypts, with the private key of the VE programmable circuit 216, the encrypted access control list to obtain an unencrypted access control list.

In the illustrated example of FIG. 6, at block 616, the programmable circuitry 230 provides, via one or more of the at least one API (e.g., the at least one hardware API 228), an encrypted memory range for the data stream to the data provider. For example, the encrypted memory range represents a reserved region in the memory 208 of the compute device 202 for storage of the data stream. Additionally, for example, the encrypted memory range is communicated to the data provider in an encrypted communication that is encrypted with the public key of the VE programmable circuit 216. In the example of FIG. 6, at block 618, the programmable circuitry 230 registers the unencrypted identifier, the unencrypted cryptographic key, the unencrypted access control list, and the memory range for the data stream in the data provider mapping table 234.

In the illustrated example of FIG. 6, at block 620, the programmable circuitry 230 accesses, from the memory controller circuitry 214 (e.g., the ACL and DAAT circuitry 404, and/or, more generally, the TME circuitry 226), an identifier of a data object to which software requested access. At block 622, the programmable circuitry 230 accesses the data provider mapping table 234 to determine whether the identifier of the data object matches the unencrypted identifier for the data stream and/or the unencrypted identifier of any other data stream logged in the data provider mapping table 234. At block 624, based on the identifier matching the unencrypted identifier, the programmable circuitry 230 provides the memory controller circuitry 214 (e.g., the ACL and DAAT circuitry 404, and/or, more generally, the TME circuitry 226) access to the unencrypted access control list and the unencrypted cryptographic key. For example, the software is executed by a programmable circuit (e.g., the programmable circuitry 212). As such, based on the identifier of the data object to which the programmable circuit requested access matching the unencrypted identifier of the data stream, the programmable circuitry 230 provides the memory controller circuitry 214 with access to the unencrypted access control list and the unencrypted cryptographic key for the data stream.

FIG. 7 is a flowchart representative of example machine-readable instructions and/or example operations 700 that may be executed, instantiated, and/or performed by example programmable circuitry to implement the memory controller circuitry 214 of FIGS. 2-4B. The example machine-readable instructions and/or the example operations 700 of FIG. 7 begin at block 702, at which the ACL and DAAT circuitry 404, and/or, more generally, the TME circuitry 226 receives a request from software to access a portion of an encrypted data object having a first identifier. For example, the ACL and DAAT circuitry 404, and/or, more generally, the TME circuitry 226 receives a request from the user software stack 220 to access the data object 206.

In the illustrated example of FIG. 7, at block 704, the ACL and DAAT circuitry 404, and/or, more generally, the TME circuitry 226 accesses a certificate for the software. For example, the certificate includes a second identifier of the software. In the example of FIG. 7, at block 706, the ACL and DAAT circuitry 404, and/or, more generally, the TME circuitry 226 provides the first identifier of the encrypted data object to the VE programmable circuit 216. For example, the ACL and DAAT circuitry 404, and/or, more generally, the TME circuitry 226 provides the first identifier to the VE programmable circuit 216 to access an access control list and a cryptographic key for the encrypted data object from the data provider mapping table 234.

In the illustrated example of FIG. 7, at block 708, the ACL and DAAT circuitry 404, and/or, more generally, the TME circuitry 226 determines, based on the access control list and the second identifier of the software, whether the software is permitted to access the portion of the encrypted data object. Based on (e.g., in response to) the ACL and DAAT circuitry 404, and/or, more generally, the TME circuitry 226 determining that the software is permitted to access the portion of the encrypted data object (block 708: YES), the machine-readable instructions and/or the operations 700 proceed to block 710. At block 710, the ACL and DAAT circuitry 404, and/or, more generally, the TME circuitry 226 accesses the encrypted data object from the memory 208.

In the illustrated example of FIG. 7, at block 712, the ACL and DAAT circuitry 404, and/or, more generally, the TME circuitry 226 decrypts the encrypted data object with the cryptographic key to obtain an unencrypted data object. At block 714, the ACL and DAAT circuitry 404, and/or, more generally, the TME circuitry 226 copies a portion of the unencrypted data object to a region of memory accessible to the software. For example, the ACL and DAAT circuitry 404, and/or, more generally, the TME circuitry 226 copies at least a decrypted portion of the encrypted data object to a region of the memory 208 accessible by the software.

Returning to block 708, based on (e.g., in response to) the ACL and DAAT circuitry 404, and/or, more generally, the TME circuitry 226 determining that the software is not permitted to access the portion of the encrypted data object (block 708: NO), the machine-readable instructions and/or the operations 700 proceed to block 716. At block 716, the ACL and DAAT circuitry 404, and/or, more generally, the TME circuitry 226 notifies the software that the software is not permitted to access the portion of the encrypted data object. As such, the memory controller circuitry 214 (e.g., the ACL and DAAT circuitry 404, and/or, more generally, the TME circuitry 226) permits or denies one or more requests to access an encrypted data object based on an access control list for the encrypted data object.

FIG. 8 is a flowchart representative of example machine-readable instructions and/or example operations 800 that may be executed, instantiated, and/or performed by example programmable circuitry to implement the user software stack 220 of FIGS. 2-4B. The example machine-readable instructions and/or the example operations 800 of FIG. 8 begin at block 802, at which the user software stack 220 connects to a data provider associated with the compute device 202. For example, the user software stack 220 connects to the data provider 204.

In the illustrated example of FIG. 8, at block 804, the user software stack 220 receives an encrypted data object from the data provider. For example, the encrypted data object is encrypted with a cryptographic key. In the example of FIG. 8, at block 806, the user software stack 220 causes storage of the encrypted data object in a memory range of the memory 208 of the compute device 202. At block 808, the user software stack 220 sends a request to the memory controller circuitry 214 (e.g., the ACL and DAAT circuitry 404, and/or, more generally, the TME circuitry 226) to access a portion of the encrypted data object.

In the illustrated example of FIG. 8, at block 810, the user software stack 220 identifies a certificate to the memory controller circuitry 214 (e.g., the ACL and DAAT circuitry 404, and/or, more generally, the TME circuitry 226). For example, the user software stack 220 sends the certificate 406 to the memory controller circuitry 214 (e.g., the ACL and DAAT circuitry 404, and/or, more generally, the TME circuitry 226). In some examples, the user software stack 220 provides, to the memory controller circuitry 214 (e.g., the ACL and DAAT circuitry 404, and/or, more generally, the TME circuitry 226), a pointer to a memory region of the secure enclave 224. In the example of FIG. 8, at block 812, based on approval from the memory controller circuitry 214 (e.g., the ACL and DAAT circuitry 404, and/or, more generally, the TME circuitry 226), the user software stack 220 accesses the portion of the encrypted data object. In the example of FIG. 8, the user software stack 220 accesses the portion of the encrypted data object from a region of the memory 208 accessible to the user software stack 220. For example, the portion of the encrypted data object is copied to the region of the memory 208 accessible to the user software stack 220 by the memory controller circuitry 214 (e.g., the ACL and DAAT circuitry 404, and/or, more generally, the TME circuitry 226) after decryption with the cryptographic key.

FIGS. 9, 10A, 10B, and 11 include example computing architectures in which any of the techniques and configurations above may be implemented.

FIG. 9 illustrates an example hardware arrangement of an example data center 900 used to provide multiple examples or instances of a computing system (e.g., the programmable circuitry platform 1100 described below), with each example of the computing system identified as a respective platform (e.g., the platform 930, described below). The data center 900 includes example data center infrastructure 901, an example data center network fabric 902, and an example power distribution unit 903 to support multiple racks of compute platforms, with a single instance of an example rack 910 depicted. The data center infrastructure 901 may provide physical components that host the compute platform hardware, storage components, and/or networking equipment. The data center network fabric 902 may include switches and/or networking components to support data flows among various compute platforms and storage devices throughout the data center. The power distribution unit 903 may include components to distribute and/or control power among the various compute platforms, networking, and storage devices.

The rack 910 of FIG. 9 includes, but is not limited to, example cooling infrastructure 911, an example network interface 912, and/or other related physical components to support discrete instances of multiple chassis. The rack 910 provides power, connectivity, and/or cooling to each of the multiple chassis in a single rack, with a single instance of a chassis 920 in the example of in FIG. 9. The chassis 920 includes, but is not limited to, example cooling infrastructure 921, an example chassis network fabric 922, and an example power supply 923, which provides cooling, network connectivity, and/or power to multiple platforms within the chassis. Although a single instance of an example platform 930 is illustrated in FIG. 9, in some examples, a common data center rack configuration may include dozens of chassis, with each chassis to support a number of platforms depending on the physical size of the platform hardware and/or supporting equipment.

The platform 930 of FIG. 9 may be referred to as a server or node, depending on the use case for the platform 930 and the data center 900. The platform 930 includes but is not limited to examples of a discrete computing system hosted on a single board. In FIG. 9, the platform 930 is illustrated as hosting a first example chip assembly 940A and a second example chip assembly 940B on a first board provided by a printed circuitry board (PCB) or other platform board, shown as an example PCB 931. In some examples, the platform 930 may include only one chip package, whereas the PCB 931 includes interconnection of multiple chip assemblies via an interface (e.g., a peripheral component interconnect express (PCIe) interface). Additional chip packages and components may also be hosted on the PCB 931.

Some examples of the chip assembly 940A, 940B of FIG. 9 may be termed as a System-on-Chip (SoC) package, as modular chiplets that perform different functions are integrated into a single package-even though this chip package is composed of multiple dies unlike a traditional SoC design that uses a single die. Other examples of the chip assembly 940A, 940B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 940A and the second chip assembly 940B of FIG. 9 are packages that include multiple chiplets and/or dies for respective functions, such as separate chiplets for processing (e.g., central processing unit (CPU) or graphical processing unit (GPU) chiplets), memory (e.g., cache or high-bandwidth memory chiplets), input/output (I/O) (e.g., I/O chiplets), acceleration (e.g., artificial intelligence (AI)/machine learning (ML) acceleration chiplets), signal processing (e.g., audio or video processing chiplets), etc. The close-up of chip assembly 940A of FIG. 9 includes an I/O Hub chiplet 941, chiplets 942, and a power supply 943. These components may be hosted on an interposer that is designed to connect multiple dies and/or components within a single semiconductor package (e.g., chip package). In some examples, the chiplets 942 may be manufactured and/or sourced separately and later assembled into the chip package to create the chip assembly 940A. Various connections may be provided among the chiplets 942, such as with the use of Universal Chiplet Interconnect Express (UCIe) interfaces and communications, and/or between chiplets and on-chip memory (e.g., high-bandwidth memory (HBM)) using HBM3 (JEDEC), Universal Memory Interface (UMI), or other memory interfaces.

FIG. 10A illustrates an example arrangement of an example chip assembly 1040A (e.g., a multi-processing core example of the first chip assembly 940A or the second chip assembly 940B of FIG. 9), with expanded views of the chiplets and processing units included herein. In FIG. 10A the chip assembly 1040A, which may constitute a SoC, SoP, SiP, and/or other type of chip package, includes chiplets such as an example chiplet 1010A, an example chiplet 1010B, etc. and associated on-package memory (e.g., high-speed memory) such as 3D-stacked, High Bandwidth Memory (HBM) instances (shown as an example HBM 1020A, an example HBM 1020B, interfaces (e.g., UCIe interfaces) shown as an example UCIe 1021A, an example UCIe 1021B, and an example I/O hub 1030 (e.g., which may be implemented by a I/O chiplet). Other hardware elements of a chip package are not included for simplicity. Although the examples disclosed herein are described in conjunction with UCLe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency protocols), etc.

The chiplets 1010A, 1010B of FIG. 10A include multiple processing units and the example processing units 1000A, 1000B, 1000C, 1000D include one or multiple cores, respectively. For example, the chiplet 1010A of FIG. 10A includes four processing units (the processing units 1000A, 1000B, 1000C, 1000D) and an example Level 3 (L3) cache 1004. The processing units 1000A, 1000B, 1000C, 1000D may include one or multiple processing cores, one or multiple caches, other processing units and/or passive and/or active elements. For example, processing unit 1000A includes two cores (an example core 1001A and an example core 1001B), vector processing unit 1002, and an example level 2 (L2) cache 1003. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 10B is an example arrangement of an example chip assembly 1040B (e.g., a multi-chiplet high-performance computing (HPC) example of chip assembly 940A, 940B), adapted for HPC applications (e.g., parallel processing operations involving thousands, millions, or more of processors and/or cores operating simultaneously). The example chip assembly 1040B illustrates placement as a SiP, SoC, and/or other package onto a platform board (e.g., the PCB 931 of FIG. 9). The platform board may be in a data center (e.g., the data center 900 of FIG. 9) or in a standalone deployment setting (e.g., in a standalone computer system, mobile computing device, autonomous device, etc.).

The chip assembly 1040B of FIG. 10B is composed of multiple chiplets, shown with four chiplets, including example chiplets 1010C, 1010D, 1010E, 1010F. The chiplets 1010C, 1010D, 1010E, 1010F include multiple processing units, such as thirty-two processing units with a corresponding level 3 (L3) cache for each processing unit. The processing units may include one or multiple cores, such as an example single-core processing unit 1000E shown as part of the chiplet 1010C. The chip assembly 1040B also includes corresponding memory resources, such as HBM elements corresponding to respective banks of processing units (e.g., HBM 1020B and HBM 1020C corresponding respective sets of processing units of chiplet 1010C), UCIe interfaces, and/or an IO Hub.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 1000, the chiplet 1010, the chip 940, and/or the platform 930 of FIGS. 9, 10A, and/or 10B) to perform operations described above for electronic systems or devices (e.g., to perform the machine-readable instructions of FIGS. 5-8, etc.). It should be further understood that software, including one or more machine-readable instructions, that facilitates processing and operations as described above, may be distributed, installed, or otherwise provided to networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

FIG. 11 is a block diagram of an example programmable circuitry platform 1100 structured to execute and/or instantiate the example machine-readable instructions and/or the example operations of FIGS. 5-8 to implement the example compute device 202 and/or the example data provider 204 of FIGS. 2-4B. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. In some examples, the programmable circuitry 1112 can be implemented by reduced instruction set computer (RISC)-V architecture and/or a chiplet (e.g., the chiplet assemblies 940A, 940B, 1040A, 1040B of FIGS. 9, 10A and/or 10B). The programmable circuitry 1112 may be implemented by one or more semiconductor based (e.g., silicon based) devices. In this example, the programmable circuitry 1112 implements the example I/O network circuitry 210, the example user software stack 220, the example system software stack 222, the example secure enclave 224, and/or, more generally, the example programmable circuitry 212, the example ACL and DAAT circuitry 404, and/or, more generally, the example TME circuitry 226, and/or, more generally, the example memory controller circuitry 214, the at least one example hardware API 228, the example programmable circuitry 230, and/or, more generally, the example VE programmable circuit 216.

In some examples, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of first circuitry at one point in time and reused by a second circuit in the first circuitry, or by a third circuit in a second circuitry at a different time.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. In this example, the non-volatile memory 1116 implements the example persistent storage 218. Access to the main memory 1114, 1116 of the illustrated example is controlled by memory controller circuitry 1117. In some examples, the memory controller circuitry 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1120 may include an output interface, such as an interface connected to a display device, an input interface such as an interface connected to an alphanumeric input device or a user interface (UI) navigation device, or a communication interface. In some examples, a connected I/O device may also include a display device, an alphanumeric input device, and/or a navigation device that is integrated into a single unit, such as a touch screen display. The communication interface may provide a connection with a network interface device used to transmit and/or receive electronic signals on the network 1126. The programmable circuitry platform 1100 may also include other interfaces or hardware in connection with a signal generation device (e.g., an audio or radio signal generation device), an output controller (e.g., for connection with a serial, universal serial bus (USB), parallel, and/or other wired or wireless connection such as which uses via infrared (IR) and/or near field communication (NFC) technologies), an input controller (e.g., for connection with sensors or peripheral devices), etc.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. In this example, the interface circuitry 1120 facilitates exchange of data with the example data provider 204 by the network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1132, which may be implemented by the machine-readable instructions of FIGS. 5-8, may be stored in the mass storage device 1128, in the volatile memory 1114, in the non-volatile memory 1116, and/or on at least one non-transitory computer-readable storage medium such as a CD or DVD which may be removable. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1132.

The instructions 1132 may reside, during execution and/or other operation of the programmable circuitry platform 1100, completely, or at least partially, within the volatile memory 1114, within non-volatile memory 1116, within the local memory 1113, within a removable storage, within a non-removable storage, and/or within the programmable circuitry 1112. Thus, any combination of the programmable circuitry 1112, the volatile memory 1114, the non-volatile memory 1116, the local memory 1113, and/or a storage device of the removable storage or non-removable storage may constitute a machine-readable medium or media. The instructions 1132, when loaded and executed by the programmable circuitry 1112, may invoke or utilize a defined instruction set 1132 of the programmable circuitry 1112, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. A RISC-V architecture and instruction set is one of several available architectures and instruction sets that may be used in examples of the compute components (e.g., the programmable circuitry 1112) described herein.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 5-8 to effectively instantiate the circuitry of FIGS. 2-4B as logic circuits to perform operations corresponding to those machine-readable instructions. In some such examples, the circuitry of FIGS. 2-4B is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 5-8.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry 1216 (sometimes referred to as an ALU), a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer-based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine-readable instructions represented by the flowchart(s) of FIGS. 5-8 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-8. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-8. As such, the FPGA circuitry 1300 may be configured and/or structured to effectively instantiate some or all of the operations/functions corresponding to the machine-readable instructions of the flowchart(s) of FIGS. 5-8 as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIGS. 5-8 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13 includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 5-8 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine-readable instructions represented by the flowchart(s) of FIGS. 5-8 to perform first operation(s)/function(s), the FPGA circuitry 1300 of FIG. 13 may be configured and/or structured to perform second operation(s)/function(s) corresponding to a second portion of the machine-readable instructions represented by the flowcharts of FIGS. 5-8, and/or an ASIC may be configured and/or structured to perform third operation(s)/function(s) corresponding to a third portion of the machine-readable instructions represented by the flowcharts of FIGS. 5-8.

It should be understood that some or all of the circuitry of FIGS. 2-4B may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIGS. 2-4B may be instantiated, for example, in one or more threads executing concurrently and/or in series. For example, the microprocessor 1200 of FIG. 12 may execute machine-readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIGS. 2-4B may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

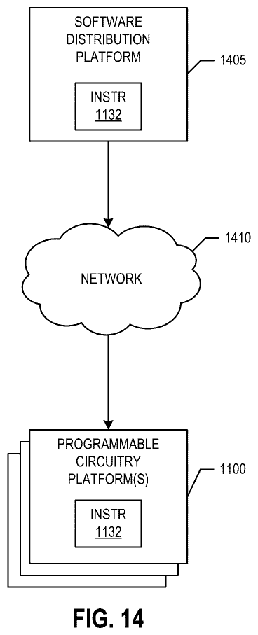

A block diagram illustrating an example software distribution platform 1405 to distribute software such as the example machine-readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine-readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine-readable instructions of FIGS. 5-8, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1132 from the software distribution platform 1405. For example, the software, which may correspond to the example machine-readable instructions of FIGS. 5-8, may be downloaded to the example programmable circuitry platform 1100, which is to execute the machine-readable instructions 1132 to implement the example compute device 202 and/or the example data provider 204. In some examples, one or more servers of the software distribution platform 1405 periodically offer, transmit, and/or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

The instructions 1132 may be transmitted or received over the network 1410 using a transmission medium via the interface circuitry 1120 of FIG. 11 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and/or wireless data networks (e.g., Institute of Electrical and Electronics Engineers (IEEE) 802.11 family of standards known as Wi-Fi®), IEEE 802.15.4 family of standards, peer-to-peer (P2P) networks, among others.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed to securely share data. For example, disclosed examples include memory hardware enforced device-encryption for vendor only access. Accordingly, disclosed systems, apparatus, articles of manufacture, and methods establish trust with data providers that data provided by a data provider will be secured and shared with only one or more data consumers defined by the data provider and only to the extent specified by the data provider. Disclosed systems, apparatus, articles of manufacture, and methods improve the efficiency of using a computing device by preventing unintended disclosure of data to potentially malicious parties. As such, the efficiency of a computing device is improved by ensuring that operation of the computing device remains uninterrupted, for example, by interference from a malicious entity that obtained access to data intended to be secure. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to methods, apparatus, and articles of manufacture to securely share data are disclosed herein. Further examples and combinations thereof include the following:

Example 1 includes an apparatus comprising at least one first programmable circuit to obtain an access control list for an encrypted data object via a first communication channel with a data provider, the encrypted data object to be provided by the data provider via a second communication channel, and memory controller circuitry to permit or deny a request from at least one second programmable circuit to access the encrypted data object based on the access control list for the encrypted data object.

Example 2 includes the apparatus of example 1, including the at least one second programmable circuit, one or more of the at least one second programmable circuit to provide the request to the memory controller circuitry.

Example 3 includes the apparatus of any of examples 1 or 2, wherein the access control list includes an encrypted access control list, and one or more of the at least one first programmable circuit is to decrypt the encrypted access control list, the encrypted access control list encrypted with a public key and decryptable with a private key.

Example 4 includes the apparatus of any of examples 1, 2 or 3, wherein the at least one first programmable circuit is to register an identifier of the encrypted data object, a cryptographic key with which the encrypted data object is to be encrypted, the access control list, and a memory range reserved in memory for the encrypted data object in a data provider mapping table, and control access to the data provider mapping table and the access control list.

Example 5 includes the apparatus of any of examples 1, 2, 3, or 4, wherein the memory controller circuitry is to determine the access control list for the encrypted data object based on a data provider mapping table controlled by the at least one first programmable circuit and an identifier of the encrypted data object, and determine whether software that initiated the request is permitted to access the encrypted data object based on the access control list and a certificate for the software.

Example 6 includes the apparatus of example 5, wherein the memory controller circuitry is to access the encrypted data object from memory, decrypt at least a portion of the encrypted data object with a cryptographic key identified in the data provider mapping table, and copy at least a decrypted portion of the encrypted data object to a region of the memory accessible by the software.

Example 7 includes the apparatus of example 5, wherein the memory controller circuitry is to notify the software if the software is not permitted to access the encrypted data object.

Example 8 includes the apparatus of any of examples 1, 2, 3, 4, 5, or 6, wherein one or more of the at least one first programmable circuit is to provide a cryptographic key for the encrypted data object to the memory controller circuitry.

Example 9 includes a method comprising obtaining, by executing an instruction with at least one first programmable circuit, an access control list for an encrypted data object via a first communication channel with a data provider, the encrypted data object to be provided by the data provider via a second communication channel, and permitting or denying, by executing an instruction with memory controller circuitry, a request from at least one second programmable circuit to access the encrypted data object based on the access control list for the encrypted data object.

Example 10 includes the method of example 9, including providing, by one or more of the at least one second programmable circuit, the request to the memory controller circuitry.

Example 11 includes the method of any of examples 9 or 10, wherein the access control list includes an encrypted access control list, and the method includes decrypting the encrypted access control list, the encrypted access control list encrypted with a public key and decryptable with a private key.

Example 12 includes the method of any of examples 9, 10, or 11, including registering an identifier of the encrypted data object, a cryptographic key with which the encrypted data object is to be encrypted, the access control list, and a memory range reserved in memory for the encrypted data object in a data provider mapping table, and controlling access to the data provider mapping table and the access control list.

Example 13 includes the method of any of examples 9, 10, 11, or 12, including determining the access control list for the encrypted data object based on a data provider mapping table controlled by the at least one first programmable circuit and an identifier of the encrypted data object, and determining whether software that initiated the request is permitted to access the encrypted data object based on the access control list and a certificate for the software.

Example 14 includes the method of example 13, including accessing the encrypted data object from memory, decrypting at least a portion of the encrypted data object with a cryptographic key identified in the data provider mapping table, and copying at least a decrypted portion of the encrypted data object to a region of the memory accessible by the software.

Example 15 includes the method of example 13, including notifying the software if the software is not permitted to access the encrypted data object.

Example 16 includes the method of any of examples 9, 10, 11, 12, 13, or 14, including providing a cryptographic key for the encrypted data object to the memory controller circuitry.

Example 17 includes a non-transitory computer-readable medium comprising instructions to program at least one programmable circuit to perform operations according to any of examples 9 to example 16.

Example 18 includes an apparatus comprising means for managing an access control list for an encrypted data object to obtain the access control list via a first communication channel with a data provider, the encrypted data object to be provided by the data provider via a second communication channel, and means for controlling access to the encrypted data object based on the access control list for the encrypted data object and an identifier provided by at least one programmable circuit in a request to access the encrypted data object.

Example 19 includes the apparatus of example 18, including the at least one programmable circuit, one or more of the at least one programmable circuit to provide the request to the means for controlling.

Example 20 includes the apparatus of any of examples 18 or 19, wherein the access control list includes an encrypted access control list, and the means for managing is to decrypt the encrypted access control list, the encrypted access control list encrypted with a public key and decryptable with a private key.

Example 21 includes the apparatus of any of examples 18, 19, or 20, wherein the identifier is a first identifier, and the means for managing is to register a second identifier of the encrypted data object, a cryptographic key with which the encrypted data object is to be encrypted, the access control list, and a memory range reserved in memory for the encrypted data object in a data provider mapping table, and control access to the data provider mapping table and the access control list.

Example 22 includes the apparatus of any of examples 18, 19, 20, or 21, wherein the identifier is a first identifier, and the means for controlling is to determine the access control list for the encrypted data object based on a data provider mapping table controlled by the means for managing and a second identifier of the encrypted data object, and determine whether software that initiated the request is permitted to access the encrypted data object based on the access control list and a certificate for the software.

Example 23 includes the apparatus of example 22, wherein the means for controlling is to access the encrypted data object from memory, decrypt at least a portion of the encrypted data object with a cryptographic key identified in the data provider mapping table, and copy at least a decrypted portion of the encrypted data object to a region of the memory accessible by the software.

Example 24 includes the apparatus of example 22, wherein the means for controlling is to notify the software if the software is not permitted to access the encrypted data object.

Example 25 includes the apparatus of any of examples 18, 19, 20, 21, 22, or 23, wherein the means for managing is to provide a cryptographic key for the encrypted data object to the means for controlling.

Example 26 includes an apparatus comprising first interface circuitry to obtain an access control list for an encrypted data object from a data provider, second interface circuitry separate from the first interface circuitry to obtain the encrypted data object from the data provider, memory to store the encrypted data object, and memory controller circuitry to permit or deny a request from at least one programmable circuit to access the encrypted data object based on the access control list for the encrypted data object.

Example 27 includes the apparatus of example 26, including the at least one programmable circuit, one or more of the at least one programmable circuit to provide the request to the memory controller circuitry.

Example 28 includes the apparatus of any of examples 26 or 27, wherein the memory controller circuitry is to access a certificate from the at least one programmable circuit based on the request, and determine whether to permit the request based on the certificate and the access control list.

Example 29 includes the apparatus of example 28, wherein the memory controller circuitry is to access a data provider mapping table with an identifier included in the certificate to determine the access control list that is to specify whether to permit the request.

Example 30 includes the apparatus of any of examples 26, 27, 28, or 29, wherein the memory controller circuitry is to, based on the at least one programmable circuit being permitted to access the encrypted data object access the encrypted data object, decrypt at least a portion of the encrypted data object with a cryptographic key for the encrypted data object, and copy at least a decrypted portion of the encrypted data object to a region of the memory accessible by the at least one programmable circuit.

Example 31 includes the apparatus of any of examples 26, 27, 28, 29, or 30, wherein the request is a first request, the at least one programmable circuit is at least one first programmable circuit, and the apparatus includes at least one second programmable circuit to register an identifier of the encrypted data object, a cryptographic key with which the encrypted data object is to be encrypted, the access control list, and a memory range reserved in memory for the encrypted data object in a data provider mapping table, and provide the memory controller circuitry with access to the access control list based on a second request from the memory controller circuitry that includes the identifier of the encrypted data object.

Example 32 includes the apparatus of any of examples 26, 27, 28, 29, or 31, wherein the memory controller circuitry is to notify the at least one programmable circuit if the at least one programmable circuit is not permitted to access the encrypted data object.

Example 33 includes the apparatus of any of examples 26, 27, 28, 29, 30, 31, or 32, wherein the memory controller circuitry is to access a cryptographic key for the encrypted data object from a compute domain separate from the at least one programmable circuit.

Example 34 includes a method comprising obtaining, via first interface circuitry, an access control list for an encrypted data object from a data provider, obtaining, via second interface circuitry separate from the first interface circuitry, the encrypted data object from the data provider, and permitting or denying, by executing an instruction with memory controller circuitry, a request from at least one programmable circuit to access the encrypted data object based on the access control list for the encrypted data object.

Example 35 includes the method of example 34, including providing the request to the memory controller circuitry.

Example 36 includes the method of any of examples 34 or 35, including accessing a certificate from the at least one programmable circuit based on the request, and determining whether to permit the request based on the certificate and the access control list.

Example 37 includes the method of example 36, including accessing a data provider mapping table with an identifier included in the certificate to determine the access control list that is to specify whether to permit the request.

Example 38 includes the method of any of examples 34, 35, 36, or 37, including, based on the at least one programmable circuit being permitted to access the encrypted data object accessing the encrypted data object, decrypting at least a portion of the encrypted data object with a cryptographic key for the encrypted data object, and copying at least a decrypted portion of the encrypted data object to a region of memory accessible by the at least one programmable circuit.

Example 39 includes the method of any of examples 34, 35, 36, 37, or 38, wherein the request is a first request, and the method includes registering an identifier of the encrypted data object, a cryptographic key with which the encrypted data object is to be encrypted, the access control list, and a memory range reserved in memory for the encrypted data object in a data provider mapping table, and providing the memory controller circuitry with access to the access control list based on a second request from the memory controller circuitry that includes the identifier of the encrypted data object.

Example 40 includes the method of any of examples 34, 35, 36, 37, or 39, including notifying the at least one programmable circuit if the at least one programmable circuit is not permitted to access the encrypted data object.

Example 41 includes the method of any of examples 34, 35, 36, 37, 38, 39, or 40, including accessing a cryptographic key for the encrypted data object from a compute domain separate from the at least one programmable circuit.

Example 42 includes a non-transitory computer-readable medium comprising instructions to program at least one programmable circuit to perform operations according to any of examples 34 to example 41.

Example 43 includes an apparatus comprising first interface circuitry to obtain an access control list for an encrypted data object from a data provider, second interface circuitry separate from the first interface circuitry to obtain the encrypted data object from the data provider, memory to store the encrypted data object, and means for controlling access to the encrypted data object, the means for controlling to permit or deny a request from at least one programmable circuit to access the encrypted data object based on the access control list for the encrypted data object.

Example 44 includes the apparatus of example 43, including the at least one programmable circuit, one or more of the at least one programmable circuit to provide the request to the means for controlling.

Example 45 includes the apparatus of any of examples 43 or 44, wherein the means for controlling is to access a certificate from the at least one programmable circuit based on the request, and determine whether to permit the request based on the certificate and the access control list.

Example 46 includes the apparatus of example 45, wherein the means for controlling is to access a data provider mapping table with an identifier included in the certificate to determine the access control list that is to specify whether to permit the request.

Example 47 includes the apparatus of any of examples 43, 44, 45, or 46, wherein the means for controlling is to, based on the at least one programmable circuit being permitted to access the encrypted data object access the encrypted data object, decrypt at least a portion of the encrypted data object with a cryptographic key for the encrypted data object, and copy at least a decrypted portion of the encrypted data object to a region of the memory accessible by the at least one programmable circuit.

Example 48 includes the apparatus of any of examples 43, 44, 45, 46, or 47, wherein the request is a first request, and the apparatus includes means for managing the access control list, the means for managing to register an identifier of the encrypted data object, a cryptographic key with which the encrypted data object is to be encrypted, the access control list, and a memory range reserved in memory for the encrypted data object in a data provider mapping table, and provide the means for controlling with access to the access control list based on a second request from the means for controlling that includes the identifier of the encrypted data object.

Example 49 includes the apparatus of any of examples 43, 44, 45, 46, or 48, wherein the means for controlling is to notify the at least one programmable circuit if the at least one programmable circuit is not permitted to access the encrypted data object.

Example 50 includes the apparatus of any of examples 43, 44, 45, 46, 47, 48, or 49, wherein the means for controlling is to access a cryptographic key for the encrypted data object from a compute domain separate from the at least one programmable circuit.

Example 51 includes a non-transitory computer-readable medium comprising instructions to cause at least one first programmable circuit to cause interface circuitry to advertise a public key of one or more of the at least one first programmable circuit, register an access control list for an encrypted data object from a data provider in a data provider mapping table, and based on a first identifier of a data object to which at least one second programmable circuit requested access matching a second identifier of the encrypted data object, provide memory controller circuitry with access to the access control list and a cryptographic key, the encrypted data object decryptable with the cryptographic key.

Example 52 includes the non-transitory computer-readable medium of example 51, wherein the instructions are to cause one or more of the at least one first programmable circuit to decrypt an encrypted version of the access control list with the public key to obtain the access control list for the encrypted data object.

Example 53 includes the non-transitory computer-readable medium of any of examples 51 or 52, wherein the instructions are to cause one or more of the at least one first programmable circuit to access, from the memory controller circuitry, the first identifier of the data object to which the at least one second programmable circuit requested access, and access the data provider mapping table to determine whether the first identifier of the data object matches the second identifier of the encrypted data object.

Example 54 includes the non-transitory computer-readable medium of any of examples 51, 52, or 53, wherein the instructions are to cause one or more of the at least one first programmable circuit to access the second identifier of the encrypted data object, access the cryptographic key, access the access control list for the encrypted data object, and register the second identifier, the cryptographic key, and the access control list in the data provider mapping table.

Example 55 includes the non-transitory computer-readable medium of example 54, wherein the instructions are to cause one or more of the at least one first programmable circuit to decrypt an encrypted version of the second identifier, an encrypted version of the cryptographic key, and an encrypted version of the access control list with the public key to obtain the second identifier, the cryptographic key, and the access control list, respectively.

Example 56 includes the non-transitory computer-readable medium of any of examples 51, 52, 53, 54, or 55, wherein the instructions are to cause one or more of the at least one first programmable circuit to provide the data provider with a memory range reserved in memory for storage of the encrypted data object.

Example 57 includes the non-transitory computer-readable medium of any of examples 51, 52, 53, 54, 55, or 56, wherein the interface circuitry includes an out-of-band interface.

Example 58 includes an apparatus comprising interface circuitry to advertise a public key, machine-readable instructions, and at least one first programmable circuit to be programmed by the machine-readable instructions to register an access control list for an encrypted data object from a data provider in a data provider mapping table, and based on a first identifier of a data object to which at least one second programmable circuit requested access matching a second identifier of the encrypted data object, provide memory controller circuitry with access to the access control list and a cryptographic key, the encrypted data object decryptable with the cryptographic key.

Example 59 includes the apparatus of example 58, wherein one or more of the at least one first programmable circuit is to decrypt an encrypted version of the access control list with the public key to obtain the access control list for the encrypted data object.

Example 60 includes the apparatus of any of examples 58 or 59, wherein one or more of the at least one first programmable circuit is to access, from the memory controller circuitry, the first identifier of the data object to which the at least one second programmable circuit requested access, and access the data provider mapping table to determine whether the first identifier of the data object matches the second identifier of the encrypted data object.

Example 61 includes the apparatus of any of examples 58, 59, or 60, wherein one or more of the at least one first programmable circuit is to access the second identifier of the encrypted data object, access the cryptographic key, access the access control list for the encrypted data object, and register the second identifier, the cryptographic key, and the access control list in the data provider mapping table.

Example 62 includes the apparatus of example 61, wherein one or more of the at least one first programmable circuit is to decrypt an encrypted version of the second identifier, an encrypted version of the cryptographic key, and an encrypted version of the access control list with the public key to obtain the second identifier, the cryptographic key, and the access control list, respectively.

Example 63 includes the apparatus of any of examples 58, 59, 60, 61, or 62, wherein one or more of the at least one first programmable circuit is to provide the data provider with a memory range reserved in memory for storage of the encrypted data object.

Example 64 includes the apparatus of any of examples 58, 59, 60, 61, 62, or 63, wherein the interface circuitry includes an out-of-band interface.

Example 65 includes a method comprising advertising, via interface circuitry, a public key of at least one first programmable circuit, registering, by executing an instruction with one or more of the at least one first programmable circuit, an access control list for an encrypted data object from a data provider in a data provider mapping table, and based on a first identifier of a data object to which at least one second programmable circuit requested access matching a second identifier of the encrypted data object, providing, by executing an instruction with one or more of the at least one first programmable circuit, memory controller circuitry with access to the access control list and a cryptographic key, the encrypted data object decryptable with the cryptographic key.

Example 66 includes the method of example 65, including decrypting an encrypted version of the access control list with the public key to obtain the access control list for the encrypted data object.

Example 67 includes the method of any of examples 65 or 66, including accessing, from the memory controller circuitry, the first identifier of the data object to which the at least one second programmable circuit requested access, and accessing the data provider mapping table to determine whether the first identifier of the data object matches the second identifier of the encrypted data object.

Example 68 includes the method of any of examples 65, 66, or 67, including accessing the second identifier of the encrypted data object, accessing the cryptographic key, accessing the access control list for the encrypted data object, and registering the second identifier, the cryptographic key, and the access control list in the data provider mapping table.

Example 69 includes the method of example 68, including decrypting an encrypted version of the second identifier, an encrypted version of the cryptographic key, and an encrypted version of the access control list with the public key to obtain the second identifier, the cryptographic key, and the access control list, respectively.

Example 70 includes the method of any of examples 65, 66, 67, 68, or 69, including providing the data provider with a memory range reserved in memory for storage of the encrypted data object.

Example 71 includes the method of any of examples 65, 66, 67, 68, 69, or 70, wherein the interface circuitry includes an out-of-band interface.

Example 72 includes an apparatus comprising interface circuitry to advertise a public key, and means for managing an access control list to register the access control list for an encrypted data object from a data provider in a data provider mapping table, and based on a first identifier of a data object to which at least one programmable circuit requested access matching a second identifier of the encrypted data object, provide means for controlling with access to the access control list and a cryptographic key, the encrypted data object decryptable with the cryptographic key.

Example 73 includes the apparatus of example 72, wherein the means for managing is to decrypt an encrypted version of the access control list with the public key to obtain the access control list for the encrypted data object.

Example 74 includes the apparatus of any of examples 72 or 73, wherein the means for managing is to access, from the means for controlling, the first identifier of the data object to which the at least one programmable circuit requested access, and access the data provider mapping table to determine whether the first identifier of the data object matches the second identifier of the encrypted data object.

Example 75 includes the apparatus of any of examples 72, 73, or 74, wherein the means for managing is to access the second identifier of the encrypted data object, access the cryptographic key, access the access control list for the encrypted data object, and register the second identifier, the cryptographic key, and the access control list in the data provider mapping table.

Example 76 includes the apparatus of example 75, wherein the means for managing is to decrypt an encrypted version of the second identifier, an encrypted version of the cryptographic key, and an encrypted version of the access control list with the public key to obtain the second identifier, the cryptographic key, and the access control list, respectively.

Example 77 includes the apparatus of any of examples 72, 73, 74, 75, or 76, wherein the means for managing is to provide the data provider with a memory range reserved in memory for storage of the encrypted data object.

Example 78 includes the apparatus of any of examples 72, 73, 74, 75, 76, or 77, wherein the interface circuitry includes an out-of-band interface.

Example 79 includes an apparatus comprising interface circuitry to obtain an identifier of an entity from a data provider, the entity having access to an access control list for an encrypted data object, at least one first programmable circuit to, via the interface circuitry, provide a certificate associated with a request to access the encrypted data object to the entity based on the identifier, the request from at least one second programmable circuit, and memory controller circuitry to permit or deny the request to access the encrypted data object based on a response from the entity.

Example 80 includes the apparatus of example 79, including the at least one second programmable circuit, one or more of the at least one second programmable circuit to provide the request to the memory controller circuitry.

Example 81 includes the apparatus of any of examples 79 or 80, wherein the identifier is a first identifier, and the memory controller circuitry is to access, from the at least one second programmable circuit, the certificate and a second identifier of the encrypted data object based on the request, and provide the certificate and the second identifier to the at least one first programmable circuit.

Example 82 includes the apparatus of any of examples 79, 80, or 81, wherein the interface circuitry is first interface circuitry, and the apparatus includes second interface circuitry separate from the first interface circuitry to obtain the encrypted data object from the data provider.

Example 83 includes the apparatus of any of examples 79, 80, 81, or 82, wherein the memory controller circuitry is to, based on the at least one second programmable circuit being permitted to access the encrypted data object access the encrypted data object, decrypt at least a portion of the encrypted data object with a cryptographic key associated with the encrypted data object, and copy at least a decrypted portion of the encrypted data object to a region of memory accessible by the at least one second programmable circuit.

Example 84 includes the apparatus of any of examples 79, 80, 81, 82, or 83, wherein the request is a first request, the identifier is a first identifier, and one or more of the at least one first programmable circuit is to register a second identifier of the encrypted data object, a cryptographic key with which the encrypted data object is to be encrypted, the first identifier, and a memory range reserved in memory for the encrypted data object in a data provider mapping table.

Example 85 includes the apparatus of any of examples 79, 80, 81, 82, or 84, wherein the memory controller circuitry is to notify the at least one second programmable circuit if the at least one second programmable circuit is not permitted to access the encrypted data object.

Example 86 includes the apparatus of any of examples 79, 80, 81, 82, 83, 84, or 85, wherein the memory controller circuitry is to access a cryptographic key for the encrypted data object from a compute domain separate from the at least one second programmable circuit.

Example 87 includes a method comprising obtaining, via interface circuitry, an identifier of an entity from a data provider, the entity having access to an access control list for an encrypted data object, providing, by executing an instruction with at least one first programmable circuit, a certificate associated with a request to access the encrypted data object to the entity based on the identifier, the request from at least one second programmable circuit, and permitting or denying, by executing an instruction with memory controller circuitry, the request to access the encrypted data object based on a response from the entity.

Example 88 includes the method of example 87, including providing the request to the memory controller circuitry.

Example 89 includes the method of any of examples 87 or 88, wherein the identifier is a first identifier, and the method includes accessing, from the at least one second programmable circuit, the certificate and a second identifier of the encrypted data object based on the request, and providing the certificate and the second identifier to the at least one first programmable circuit.

Example 90 includes the method of any of examples 87, 88, or 89, wherein the interface circuitry is first interface circuitry, and the method includes obtaining, via second interface circuitry separate from the first interface circuitry, the encrypted data object from the data provider.

Example 91 includes the method of any of examples 87, 88, 89, or 90, including, based on the at least one second programmable circuit being permitted to access the encrypted data object accessing the encrypted data object, decrypting at least a portion of the encrypted data object with a cryptographic key associated with the encrypted data object, and copying at least a decrypted portion of the encrypted data object to a region of memory accessible by the at least one second programmable circuit.

Example 92 includes the method of any of examples 87, 88, 89, 90, or 91, wherein the request is a first request, the identifier is a first identifier, and the method includes registering a second identifier of the encrypted data object, a cryptographic key with which the encrypted data object is to be encrypted, the first identifier, and a memory range reserved in memory for the encrypted data object in a data provider mapping table.

Example 93 includes the method of any of examples 87, 88, 89, 90, or 92, including notifying the at least one second programmable circuit if the at least one second programmable circuit is not permitted to access the encrypted data object.

Example 94 includes the method of any of examples 87, 88, 89, 90, 91, 92, or 93, including accessing a cryptographic key for the encrypted data object from a compute domain separate from the at least one second programmable circuit.

Example 95 includes a non-transitory computer-readable medium comprising instructions to program at least one programmable circuit to perform operations according to any of examples 87 to example 94.

Example 96 includes an apparatus comprising interface circuitry to obtain an identifier of an entity from a data provider, the entity having access to an access control list for an encrypted data object, means for managing the access control list to, via the interface circuitry, provide a certificate associated with a request to access the encrypted data object to the entity based on the identifier, the request from at least one programmable circuit, and means for controlling access to the encrypted data object, the means for controlling to permit or deny the request to access the encrypted data object based on a response from the entity.

Example 97 includes the apparatus of example 96, including the at least one programmable circuit, one or more of the at least one programmable circuit to provide the request to the means for controlling.

Example 98 includes the apparatus of any of examples 96 or 97, wherein the identifier is a first identifier, and the means for controlling is to access, from the at least one programmable circuit, the certificate and a second identifier of the encrypted data object based on the request, and provide the certificate and the second identifier to the means for managing.

Example 99 includes the apparatus of any of examples 96, 97, or 98, wherein the interface circuitry is first interface circuitry, and the apparatus includes second interface circuitry separate from the first interface circuitry to obtain the encrypted data object from the data provider.

Example 100 includes the apparatus of any of examples 96, 97, 98, or 99, wherein the means for controlling is to, based on the at least one programmable circuit being permitted to access the encrypted data object access the encrypted data object, decrypt at least a portion of the encrypted data object with a cryptographic key associated with the encrypted data object, and copy at least a decrypted portion of the encrypted data object to a region of memory accessible by the at least one programmable circuit.

Example 101 includes the apparatus of any of examples 96, 97, 98, 99, or 100, wherein the request is a first request, the identifier is a first identifier, and the means for managing is to register a second identifier of the encrypted data object, a cryptographic key with which the encrypted data object is to be encrypted, the first identifier, and a memory range reserved in memory for the encrypted data object in a data provider mapping table.

Example 102 includes the apparatus of any of examples 96, 97, 98, 99, or 101, wherein the means for controlling is to notify the at least one programmable circuit if the at least one programmable circuit is not permitted to access the encrypted data object.

Example 103 includes the apparatus of any of examples 96, 97, 98, 99, 100, 101, or 102, wherein the means for controlling is to access a cryptographic key for the encrypted data object from a compute domain separate from the at least one programmable circuit.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1.-25. (canceled)

26. An apparatus comprising:
first interface circuitry to obtain an access control list for an encrypted data object from a data provider;
second interface circuitry separate from the first interface circuitry to obtain the encrypted data object from the data provider;
memory to store the encrypted data object; and
memory controller circuitry to permit or deny a request from at least one programmable circuit to access the encrypted data object based on the access control list for the encrypted data object.

27. The apparatus of claim 26, including the at least one programmable circuit, one or more of the at least one programmable circuit to provide the request to the memory controller circuitry.

28. The apparatus of claim 26, wherein the memory controller circuitry is to:
access a certificate from the at least one programmable circuit based on the request; and
determine whether to permit the request based on the certificate and the access control list.

29. The apparatus of claim 28, wherein the memory controller circuitry is to access a data provider mapping table with an identifier included in the certificate to determine the access control list that is to specify whether to permit the request.

30. The apparatus of claim 26, wherein the memory controller circuitry is to, based on the at least one programmable circuit being permitted to access the encrypted data object:
access the encrypted data object;
decrypt at least a portion of the encrypted data object with a cryptographic key for the encrypted data object; and
copy at least a decrypted portion of the encrypted data object to a region of the memory accessible by the at least one programmable circuit.

31. The apparatus of claim 26, wherein the request is a first request, the at least one programmable circuit is at least one first programmable circuit, and the apparatus includes at least one second programmable circuit to:
register an identifier of the encrypted data object, a cryptographic key with which the encrypted data object is to be encrypted, the access control list, and a memory range reserved in memory for the encrypted data object in a data provider mapping table; and
provide the memory controller circuitry with access to the access control list based on a second request from the memory controller circuitry that includes the identifier of the encrypted data object.

32. The apparatus of claim 26, wherein the memory controller circuitry is to notify the at least one programmable circuit if the at least one programmable circuit is not permitted to access the encrypted data object.

33. The apparatus of claim 26, wherein the memory controller circuitry is to access a cryptographic key for the encrypted data object from a compute domain separate from the at least one programmable circuit.

34.-42. (canceled)

43. An apparatus comprising:
first interface circuitry to obtain an access control list for an encrypted data object from a data provider;
second interface circuitry separate from the first interface circuitry to obtain the encrypted data object from the data provider;
memory to store the encrypted data object; and
means for controlling access to the encrypted data object, the means for controlling to permit or deny a request from at least one programmable circuit to access the encrypted data object based on the access control list for the encrypted data object.

44. The apparatus of claim 43, including the at least one programmable circuit, one or more of the at least one programmable circuit to provide the request to the means for controlling.

45. The apparatus of claim 43, wherein the means for controlling is to:
access a certificate from the at least one programmable circuit based on the request; and
determine whether to permit the request based on the certificate and the access control list.

46. The apparatus of claim 45, wherein the means for controlling is to access a data provider mapping table with an identifier included in the certificate to determine the access control list that is to specify whether to permit the request.

47. The apparatus of claim 43, wherein the means for controlling is to, based on the at least one programmable circuit being permitted to access the encrypted data object:
access the encrypted data object;
decrypt at least a portion of the encrypted data object with a cryptographic key for the encrypted data object; and
copy at least a decrypted portion of the encrypted data object to a region of the memory accessible by the at least one programmable circuit.

48. The apparatus of claim 43, wherein the request is a first request, and the apparatus includes means for managing the access control list, the means for managing to:
register an identifier of the encrypted data object, a cryptographic key with which the encrypted data object is to be encrypted, the access control list, and a memory range reserved in memory for the encrypted data object in a data provider mapping table; and
provide the means for controlling with access to the access control list based on a second request from the means for controlling that includes the identifier of the encrypted data object.

49. The apparatus of claim 43, wherein the means for controlling is to notify the at least one programmable circuit if the at least one programmable circuit is not permitted to access the encrypted data object.

50. The apparatus of claim 43, wherein the means for controlling is to access a cryptographic key for the encrypted data object from a compute domain separate from the at least one programmable circuit.

51.-103. (canceled)

104. A non-transitory computer-readable medium comprising instructions to cause at least one first programmable circuit of a compute device to:
obtain an access control list for an encrypted data object from first interface circuitry, the access control list from a data provider; and
permit or deny a request from at least one second programmable circuit of the compute device to access the encrypted data object based on the access control list for the encrypted data object, the at least one second programmable circuit to obtain the encrypted data object from second interface circuitry separate from the first interface circuitry, the encrypted data object from the data provider.

105. The non-transitory computer-readable medium of claim 104, wherein the instructions cause one or more of the at least one first programmable circuit to:
access a certificate from the at least one second programmable circuit based on the request; and
determine whether to permit the request based on the certificate and the access control list.

106. The non-transitory computer-readable medium of claim 105, wherein the instructions cause one or more of the at least one first programmable circuit to access a data provider mapping table with an identifier included in the certificate to determine the access control list that is to specify whether to permit the request.

107. The non-transitory computer-readable medium of claim 104, wherein the instructions cause one or more of the at least one first programmable circuit to, based on the at least one second programmable circuit being permitted to access the encrypted data object:
access the encrypted data object;
decrypt at least a portion of the encrypted data object with a cryptographic key for the encrypted data object; and
copy at least a decrypted portion of the encrypted data object to a region of memory accessible by the at least one second programmable circuit.
